(19) United States
(12) Patent Application Publication
(10) Pub. No.: US 2015/0044602 A1
(43) Pub. Date: Feb. 12, 2015

(54) ELECTROSTATIC IMAGE-DEVELOPING TONER, ELECTROSTATIC IMAGE DEVELOPER, TONER CARTRIDGE, PROCESS CARTRIDGE, IMAGE FORMING APPARATUS AND IMAGE FORMING METHOD

(71) Applicant: FUJI XEROX CO., LTD., Tokyo (JP)

(72) Inventors: Soichiro KITAGAWA, Minamiashigara-shi (JP); Shinpei TAKAGI, Minamiashigara-shi (JP); Kiyohiro YAMANAKA, Minamiashigara-shi (JP); Tomohiro SHINYA, Minamiashigara-shi (JP)

(73) Assignee: FUJI XEROX CO., LTD., Tokyo (JP)

(21) Appl. No.: 14/255,555

(22) Filed: Apr. 17, 2014

(30) Foreign Application Priority Data
Aug. 6, 2013 (JP) 2013-163489
Aug. 23, 2013 (JP) 2013-173518

(51) Int. Cl. G03G 9/00

(52) U.S. Cl. CPC G03G 9/08728; G03G 2215/066; G03G 2221/183
USPC 430/105; 430/109.4; 430/109.3

(57) ABSTRACT

There is provided an electrostatic image-developing toner containing an amorphous polyester resin, a crystalline polyester resin, and a resin particle incompatible with the amorphous polyester resin, wherein the amorphous polyester resin contains an amorphous polyester resin having an ethylenically unsaturated bond and a surface layer part contains a crosslinking product of the amorphous polyester resin having an ethylenically unsaturated bond.

### CROSS-REFERENCE TO RELATED APPLICATIONS

This application is based on and claims priority under 35 USC 119 from Japanese Patent Application No. 2013-163489 filed on Aug. 6, 2013 and Japanese Patent Application No. 2013-173518 filed on Aug. 23, 2013.

### BACKGROUND

1. Field

The present invention relates to an electrostatic image-developing toner, an electrostatic image developer, a toner cartridge, a process cartridge, an image forming apparatus, and an image forming method,

2. Description of the Related Art

In recent years, an image forming apparatus typified by a printer or a copying machine is widespread, and techniques related to various elements constituting the image forming apparatus are also spread widely. Among image forming apparatuses, in an image forming apparatus employing an electrophotographic system, a pattern intended to be printed is often formed by charging a photoreceptor (image holding member) by means of a charging device and forming, on the charged photoreceptor, an electrostatic image having a potential different from the ambient potential. The electrostatic image formed in this way is developed with a toner-containing developer and then is finally transferred onto a recording medium such as recording paper.

Here, in order to provide a toner particle having desired gloss properties, there is disclosed a process including: a step of bringing at least one amorphous resin into contact with at least one crystalline resin in an aqueous emulsion to form a small particle, which is a step where the emulsion contains an optionally added coloring agent, an optionally added surfactant and an optionally added wax; a step of aggregating the small particles to form a plurality of larger aggregates; a step of contacting the larger aggregate into contact with the emulsion containing at least one amorphous resin and/or at least another one amorphous resin to form a resin coating covering the larger aggregate; a step of coalescing the larger aggregate in the resin coating and simultaneously with or after the coalescence, crosslinking the larger aggregate and/or the resin coating to form a plurality of crosslinked particles each having a core and a shell; a step of adding at least one water-soluble initiator in any stage before the formation of crosslinked particle in the process; and a step of collecting the crosslinked particles (see, for example, JP-A-2010-055092 (the term “JP-A” as used herein means an “unexamined published Japanese patent application”)).

Also, in order to provide a production method of a toner, where a toner enabling formation of a high-quality image, having excellent low-temperature fixing property as well as high temperature-resistant offset property, being capable of providing appropriate gloss to the formed image, and ensuring high reproducibility of density gradation can be stably produced, there is disclosed a method for producing an electrostatic image-developing toner, including passing through (a-1) a step of preparing an aqueous medium dispersion liquid of particles derived from a crystalline polyester resin, (a-2) a step of preparing an aqueous medium dispersion liquid of particles derived from an amorphous polyester resin containing a polymerizable unsaturated bond, (b) a step of aggregating at least the particles derived from an amorphous polyester resin in an aqueous medium to form a core aggregated particle, (c) a step of attaching a particle derived from an amorphous polyester resin containing a polymerizable unsaturated bond to the surface of the core aggregated particle to form a core-shell aggregated particle, and (d) a step of causing a radial polymerization initiator to act on the core-shell aggregated particle to perform a radical polymerization reaction and thereby form, on the core aggregated surface, a layer composed of an amorphous polyester resin having a crosslinked structure (see, for example, JP-A-2012-098427).

Here, in order to provide a production method of an electrostatic image-developing toner, where a toner enabling formation of a high-quality image, having excellent low-temperature fixing property as well as having heat-resistant storability and excellent high temperature-resistant offset property, and being capable of providing appropriate gloss to the formed image can be stably produced, there is disclosed a method for producing an electrostatic image-developing toner, including passing through (a-1) a step of producing an aqueous medium dispersion liquid of particles derived from a crystalline polyester resin, (a-2) a step of producing an aqueous medium dispersion liquid of particles derived from an amorphous polyester resin containing a polymerizable unsaturated double bond, (b) a step of aggregating at least a particle derived from the crystalline polyester resin and a particle derived from the amorphous polyester resin containing a polymerizable unsaturated bond in an aqueous medium to form an aggregated particle, and (c) a step of causing a radial polymerization initiator to act on the aggregated particle to perform a radical polymerization reaction and thereby produce a polyester resin having a crosslinked structure (see, for example, JP-A-2012-141523).

### SUMMARY

[1] An electrostatic image-developing toner containing:

an amorphous polyester resin,

a crystalline polyester resin, and

a resin particle incompatible with the amorphous polyester resin,

wherein

the amorphous polyester resin contains an amorphous polyester resin having an ethylenically unsaturated bond, and

a surface layer part contains a crosslinking product of the amorphous polyester resin having an ethylenically unsaturated bond.

### BRIEF DESCRIPTION OF DRAWINGS

Exemplary embodiments of the present invention will be described in detail based on the following figures, wherein:

FIG. 1 is a view illustrating an example of the measurement results of tan δ of the toner.

FIG. 2 is a schematic configuration diagram illustrating an example of the image forming apparatus according to an exemplary embodiment of the present invention.

FIG. 3 is a schematic configuration diagram illustrating an example of the process cartridge according to an exemplary embodiment of the present invention.

### DETAILED DESCRIPTION

Exemplary embodiments of the electrostatic image-developing toner, electrostatic image developer, toner cartridge, process cartridge, image forming apparatus and image forming embodiment of the present invention are described in detail below.

### <Electrostatic Image-Developing Toner>

The electrostatic image-developing toner according to a first exemplary embodiment of the present invention (hereinafter, sometimes simply referred to as “toner”) is firstly described below.

The electrostatic image-developing toner according to the first exemplary embodiment of the present invention contains an amorphous polyester resin, a crystalline polyester resin, and a resin particle incompatible with the amorphous polyester resin, wherein the amorphous polyester resin contains an amorphous polyester resin having an ethylenically unsaturated bond and the surface layer part contains a crosslinking product of the amorphous polyester resin having an ethylenically unsaturated bond.

Conventionally, in order to achieve a low-temperature fixing property of a toner, the tone must be designed to decrease in its melt viscosity by using a fixing aid such as crystalline resin and wax. However, decrease in the melt viscosity allows blocking of the toner to readily occur, and powder properties of the toner may be deteriorated. Furthermore, when the melt viscosity is decreased using a fixing aid having crystallinity, the sensitivity of melt viscosity of the toner to the fixing temperature becomes high, and there is a problem that the variation in image gloss for the fixing temperature is increased.

The toner according to the first exemplary embodiment of the present invention exhibits an excellent low-temperature fixing property and gives less variation in image gloss. The reason therefor is not clearly known but is presumed as follows.

Toner blocking is considered to occur due to fusion bonding of the toner particle surface. For preventing fusion bonding from occurring on the toner surface, raising the glass transition temperature of the toner is effective, but when the glass transition of the toner is raised, the low-temperature fixing property may be deteriorated. In order to prevent fusion bonding of the toner particle surface but not to deteriorate the low-temperature fixing property, an embodiment of selectively raising the glass transition temperature of the toner particle surface without causing a great effect on the glass transition temperature of the whole toner is preferred. In an exemplary embodiment of the present invention, the surface layer part of the toner contains a crosslinking product of an amorphous polyester resin having an ethylenically unsaturated bond It is presumed that thanks to this configuration, the glass transition temperature of the toner particle surface rises compared to the inside of the toner particle, as a result, the low-temperature fixing property is realized while suppressing generation of toner blocking.

On the other hand, compatibility of the crystalline polyester resin is enhanced by using an amorphous polyester resin and a crystalline polyester resin in combination as constituent components of the toner. Therefore, along with the lowering of viscosity at the fusion bonding temperature of the crystalline polyester resin, the viscosity of the amorphous polyester resin is also lowered and sharp meltability (sharp melting properties) as a toner is obtained, which is advantageous in view of low-temperature fixing property. However, when the toner has sharp meltability, image gloss is sometimes likely to vary depending on the fixing temperature of the toner. It is presumed that the image gloss is affected by the smoothness of toner image surface and when a resin particle incompatible with an amorphous polyester resin is used as a constituent component of the toner, the resin particle affects the smoothness of the toner image surface, as a result, the variation in toner image gloss is reduced.

The toner according to the first exemplary embodiment of the present invention is described in detail below.

The toner according to the first exemplary embodiment of the present invention is configured to contain a toner particle and, if desired, an external additive,

### (Toner Particle)

The toner particle is configured to contain, for example, a binder resin and a resin particle incompatible with an amorphous polyester resin and, if desired, contain a coloring agent, a release agent and other additives.

### —Binder Resin—

In the first exemplary embodiment of the present invention, an amorphous polyester resin and a crystalline polyester resin are used in combination as the binder resin. The amorphous polyester resin contains an amorphous polyester resin having an ethylenically unsaturated bond (hereinafter, sometimes referred to as an amorphous unsaturated polyester resin). In the first exemplary embodiment of the present invention, the amorphous unsaturated polyester resin is used at least as a part of the amorphous polyester resin. Incidentally, in the first exemplary embodiment of the present invention, for the sake of distinction from the amorphous unsaturated polyester resin, an amorphous polyester resin having no ethylenically unsaturated bond or having an ethylenically unsaturated bond where, however, the bond does not have reactivity, is sometimes referred to as an amorphous saturated polyester resin. The “reactivity” as used herein indicates that when the resin as a particle of about 200 nm is heated at 80° C. while stirring a 30 mass % water dispersion liquid thereof and reacted for 2 hours by adding a polymerization initiator (APS, produced by Mitsubishi Chemical Corporation) in an amount of 5 mass % based on the resin, the gel content (THF-insoluble content) of the resin particle after solid separation in a freeze dryer is increased by 3 mass % or more between before and after the reaction.

Incidentally, the “crystalline” of the resin means to have a definite endothermic peak, not a stepwise change of endothermic heat quantity, in the differential scanning calorimetry (DSC), and specifically indicates that the half-value width of the endothermic peak when measured at a temperature rise rate of 10 (° C./min) is within 10° C.

On the other hand, the “amorphous” of the resin indicates that the half-value width exceeds 10° C. or a stepwise change in the endothermic peak or no definite endothermic peak is observed.

### Amorphous Saturated Polyester Resin

The amorphous saturated polyester resin includes, for example, a condensation polymer of a polyvalent carboxylic acid and a polyhydric alcohol. Incidentally, as the amorphous saturated polyester resin, a commercially available product may be used, or a synthesized resin may be used.

The polyvalent carboxylic acid includes, for example, an aliphatic dicarboxylic acid (such as oxalic acid, malonic acid, succinic acid, adipic acid and sebacic acid), an alicyclic dicarboxylic acid (such as cyclohexanedicarboxylic acid), an aromatic dicarboxylic acid (such as terephthalic acid, isophthalic acid, phthalic acid and naphthalenedicarboxylic acid), an anhydride thereof, and a lower (for example, a carbon number of 1 to 5) alkyl ester thereof. Among these, the polyvalent carboxylic acid is preferably, for example, an aromatic dicarboxylic acid.

As the polyvalent carboxylic acid, together with the dicarboxylic acid, a trivalent or higher valent carboxylic acid having a crosslinked structure or a branched structure may be used in combination. The trivalent or higher valent carboxylic acid includes, for example, a trimellitic acid, a pyromellitic acid, an anhydride thereof, and a lower (for example, a carbon number of 1 to 5) alkyl ester thereof.

One of these polyvalent carboxylic acids may be used alone, or two or more thereof may be used in combination.

The polyhydric alcohol includes, for example, an aliphatic diol (such as ethylene glycol, diethylerie glycol, triethylene glycol, propylene glycol, butanediol, hexanediol and neopentyl glycol), an alicyclic dial (such as cyclohexanediol, cyclohexanedimethanol and hydrogenated bisphenol A), and an aromatic diol (such as an ethylene oxide adduct of bisphenol A, and a propylene oxide adduct of bisphenol A). Among these, the polyhydric alcohol is preferably, for example, an aromatic diol or an alicyclic diol, more preferably an aromatic dial.

As the polyhydric alcohol, together with the dial, a trihydric or higher polyhydric alcohol having a crosslinked structure or a branched structure may be used in combination. The trihydric or higher polyhydric alcohol includes, for example, glycerin, trimethylolpropane, and pentaerythritol.

One of these polyhydric alcohols may be used alone, or two or more thereof may be used in combination.

The glass transition temperature (Tg) of the amorphous saturated polyester resin is preferably from 50° C. to 80° C., more preferably from 50° C. to 65° C.

Incidentally, the glass transition temperature is determined from a DSC curve obtained by differential scanning calorimetry (DSC), more specifically, is determined as the “extrapolated glass transition initiation temperature” described in the determination method of glass transition temperature of SIS K7121-1987, “Method for Measuring Transition Temperature of Plastics”.

The weight average molecular weight (Mw) of the amorphous saturated polyester resin is preferably from 5,000 to 1,000,000, more preferably from 7,000 to 500,000.

The number average molecular weight (Mn) of the amorphous saturated polyester resin is preferably from 2,000 to 100,000.

The molecular weight distribution Mw/Mn of the amorphous saturated polyester resin is preferably from 1.5 to 100, more preferably from 2 to 60.

Incidentally, the weight average molecular weight and the number average molecular weight are measured by gel permeation chromatography (GPC). The measurement of molecular weight by GPC is performed with a THF solvent by using GPC HLC-8120, manufactured by Tosoh Corporation as the measuring apparatus and using a TSKgel Super HM-M column (15 cm) manufactured by Tosoh Corporation. The weight average molecular weight and the number average molecular weight are calculated from the measurement results by using a molecular weight calibration curve prepared from a monodisperse polystyrene standard sample.

The amorphous saturated polyester resin is obtained by a known production method and specifically, for example, by a method where the polymerization temperature is set to be from 180° C. to 230° C. and, if desired, after reducing the pressure in the reaction system, the reaction is performed while removing water or alcohol generated during condensation.

Incidentally, in the case where a raw material monomer is insoluble or incompatible at the reaction temperature, the monomer may be dissolved by adding a high-boiling-point solvent as a dissolution aid. In this case, the polycondensation reaction is performed while distilling out the dissolution aid. In the case where a monomer with poor compatibility is present in the copolymerization reaction, the poorly compatible monomer may be previously condensed with an acid or alcohol to be polycondensed with the monomer and then polycondensed together with the main component.

Crystalline Polyester Resin

The crystalline polyester resin includes, for example, a polycondensate of a polyvalent carboxylic acid and a polyhydric alcohol. Incidentally, as the crystalline polyester resin, a commercially available product may be used, or a synthesized resin may be used.

Here, the crystalline polyester resin is preferably a polycondensate using a polymerizable monomer having a linear aliphatic component rather than a polymerizable monomer having an aromatic component, because a crystal structure is easily formed.

The polyvalent carboxylic acid includes, for example, an aliphatic dicarboxylic acid (such as oxalic acid, succinic acid, glutaric acid, adipic acid, suberic acid, azelaic acid, sebacic acid, 1,9-nonane dicarboxylic acid, 1,10-decane dicarboxylic acid, 1,12-dodecanedicarboxylic acid, 1,14-tetradecanedicarboxylic acid and 1,18-octadecanedicarboxylic acid), an aromatic dicarboxylic acid (for example, a dibasic acid such as phthalic acid, isophthalic acid, terephthalic acid and naphthalene-2,6-dicarboxylic acid), an anhydride thereof, and a lower (for example, a carbon number of 1 to 5) alkyl ester thereof.

As the polyvalent carboxylic acid, together with the dicarboxylic acid, a trivalent or higher valent carboxylic acid having a crosslinked structure or a branched structure may be used in combination. The trivalent carboxylic acid includes, for example, an aromatic carboxylic acid (such as 1,2,3-benzene tricarboxylic acid, 1,2,4-benzene tricarboxylic acid and 1,2,4-naphthalene tricarboxylic acid), an anhydride thereof, and a lower (for example, a carbon number of 1 to 5) alkyl ester thereof.

As the polyvalent carboxylic acid, together with these dicarboxylic acids, a sulfonic acid group-containing dicarboxylic acid or an ethylenic double bond-containing dicarboxylic acid may be used in combination.

One of these polyvalent carboxylic acids may be used alone, or two or more thereof may be used in combination.

The polyhydric alcohol includes, for example, an aliphatic diol (for example, a linear aliphatic diol with the main chain moiety having a carbon number of 7 to 20). The aliphatic diol includes, for example, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these aliphatic diols, 1,8-octanediol, 1,9-nonanediol and 1,10-decanediol are preferred.

As the polyhydric alcohol, together with the dial, a trihydric or higher alcohol having a crosslinked structure or a branched structure may be used in combination. The trihydric or higher alcohol includes, for example, glycerin, trimethylolethane, trimethylolpropane, and pentaerythritol.

One of these polyhydric alcohols may be used alone, or two or more thereof may be used in combination.

Here, the content of the aliphatic diol in the polyhydric alcohols is preferably 80 mol % or more, more preferably 90 mol % or more.

The melting temperature of the crystalline polyester resin is preferably from 50° C. to 100° C., more preferably from 55° C. to 90° C., still more preferably from 60° C. to 85° C.

Incidentally, the melting temperature is determined from a DSC curve obtained by differential scanning calorimetry (DSC), as the “melting peak temperature” described in the determination method of melting temperature of JIS K7121-1987, “Method for Measuring Transition Temperature of Plastics”.

The weight average molecular weight (Mw) of the crystalline polyester resin is preferably from 6,000 to 35,000.

The crystalline polyester resin is obtained, for example, by a known production method, similarly to the amorphous saturated polyester resin.

Amorphous Unsaturated Polyester Resin

The amorphous unsaturated polyester resin for use in an exemplary embodiment of the present invention is not particularly limited as long as it is a resin having an ethylenically unsaturated bond in the molecule.

The unsaturated bond equivalent of the amorphous unsaturated polyester resin for use in an exemplary embodiment of the present invention is preferably 4,000 g/eq or less, more preferably 1,500 g/eq or less, still more preferably 1,000 g/eq or less.

In the first exemplary embodiment of the present invention, the unsaturated bond equivalent of the resin indicates the value measured by the following method.

NMR analysis (H analysis) of the resin is performed to identify the monomer species and compositional ratio and by determining the proportion of a monomer having an unsaturated double bond therefrom, the molecular weight per unsaturated bond is calculated.

The amorphous unsaturated polyester resin is an amorphous polyester resin having an ethylenically unsaturated bond (for example, a vinyl group or a vinylene group) in the molecule.

Specifically, the amorphous unsaturated polyester resin is, for example, a condensation polymer of a polyvalent carboxylic acid and a polyhydric alcohol and is preferably a polyester resin where a monomer having an ethylenically unsaturated bond (for example, a vinyl group or a vinylene group) working out to an unsaturated polyester component is used as at least either one member of the polyvalent carboxylic acid and the polyhydric alcohol.

Among others, in view of stability, a condensation polymer of a polyvalent carboxylic acid having an ethylenically unsaturated bond (for example, a vinyl group or a vinylene group) and preferably a polyhydric alcohol is preferred as the amorphous unsaturated polyester resin, and a condensation polymer of a divalent carboxylic acid having an ethylenically unsaturated bond (for example, a vinyl group or a vinylene group) and a dihydric alcohol (namely, a linear polyester resin) is more preferred as the amorphous unsaturated polyester resin.

In the case where the amorphous unsaturated polyester resin is a condensation polymer of an ethylenically unsaturated bond-containing polyvalent carboxylic acid and a polyhydric alcohol, a polyvalent carboxylic acid not having an ethylenically unsaturated bond may be used as a part of the polyvalent carboxylic acid, if desired. Specific examples of the polyvalent carboxylic acid not having an ethylenically unsaturated bond include polyvalent carboxylic acids recited in the paragraph of Amorphous Saturated Polyester Resin.

The divalent carboxylic acid having an ethylenically unsaturated bond (for example, a vinyl group or a vinylene group) includes, for example, a fumaric acid, a maleic acid, a maleic anhydride, a citraconic acid, a mesaconic acid, an itaconic acid, a glutaconic acid, an allylmalonic acid, an isopropylidenesuccinic acid, an acetylenedicarboxylic acid, and a lower (a carbon number of 1 to 4) alkyl ester thereof.

The trivalent or higher valent carboxylic acid having an ethylenically unsaturated bond (for example, a vinyl group or a vinylene group) includes an aconitic acid, a 3-butene-1,2,3-tricarboxylic acid, a 4-pentene-1,2,4-tricarboxylic acid, a 1-pentene-1,1,4,4,-tetracarboxylic acid, and a lower (a carbon number of 1 to 4) alkyl ester thereof.

One of these polyvalent carboxylic acids may be used alone, or two or more thereof may be used in combination.

The dihydric alcohol includes, for example, bisphenol A, hydrogenated bisphenol A, an ethylene oxide or propylene oxide adduct of bisphenol A, 1,4-cyclohexanediol, 1,4-cyclohexanedimethanol, ethylene glycol, diethylene glycol, propylene glycol, dipropylene glycol, 1,3-butanediol, 1,4-butanediol, 1,5-pentanediol, 1,6-hexanediol, 1,9-nonanediol, and neopentyl glycol

The trihydric or higher alcohol includes, for example, glycerin, trimethylolethane, trimethylolpropane, and pentaerythritol.

Incidentally, together with the polyhydric alcohol, a monovalent acid such as acetic acid and benzoic acid, or a monohydric alcohol such as cyclohexanol and benzyl alcohol may be used in combination, if desired, for the purpose of, for example, adjusting the acid value or hydroxyl group value.

One of these polyhydric alcohols may be used alone, or two or more thereof may be used in combination.

Among these amorphous unsaturated polyester resins that are a condensation polymer of a polyvalent carboxylic acid and a polyhydric alcohol, a condensation polymer of at least one divalent carboxylic acid selected from a fumaric acid, a maleic acid and a maleic anhydride, and a dihydric alcohol is preferred.

That is, the unsaturated polyester component of the amorphous unsaturated polyester resin is preferably a component derived from at least one divalent carboxylic acid selected from a fumaric acid, a maleic acid and a maleic anhydride.

The percentage of the ethylenically unsaturated bond-containing monomer in the total of a polyvalent carboxylic acid and a polyhydric alcohol constituting the amorphous unsaturated polyester resin is preferably from 5 mol % to 25 mol %, more preferably from 10 mol % to 22.5 mol %.

Also, the percentage of the ethylenically unsaturated bond-containing monomer (polyvalent carboxylic acid) in the total of polyvalent carboxylic acids is preferably from 12.5 mol % to 22.5 mol %, more preferably from 12.5 mol % to 20 mol %.

The production method of the amorphous unsaturated polyester resin is not particularly limited, and a method in accordance with the above-described method for the amorphous saturated polyester resin may be used.

The weight average molecular weight (Mw) of the amorphous unsaturated polyester resin is, for example, preferably from 30,000 to 300,000, more preferably from 30,000 to 200,000, still more preferably from 35,000 to 150,000.

The glass transition temperature (Tg) of the amorphous unsaturated polyester resin is, for example, preferably from 50° C. to 80° C., more preferably from 50° C. to 65° C.

Incidentally, the glass transition temperature of the amorphous unsaturated polyester resin is determined as the peak temperature of endothermic peak obtained by differential scanning calorimetry (DSC).

The content of the binder resin is, for example, preferably from 40 mass % to 95 mass %, more preferably from 50 mass % to 90 mass %, still more preferably from 60 mass % to 85 mass %, based on the entire toner particle.

As for the percentage of the crystalline polyester resin in the entire binder resin, the content of the polyester resin used is preferably from 2 mass % to 40 mass % (preferably from 2 mass % to 20 mass %) based on all binder resins.

As for the percentage of the amorphous unsaturated polyester resin in the entire amorphous polyester resin, the content of the amorphous unsaturated polyester resin used is preferably from 30 mass % to 100 mass % (preferably from 40 mass % to 80 mass %) based on all amorphous polyester resins.

—Resin Particle Incompatible with Amorphous Polyester Resin—

In the first exemplary embodiment of the present invention, a resin particle (hereinafter, sometimes referred to as an incompatible resin particle) incompatible with the amorphous polyester resin is used.

Whether or not the incompatible resin particle is incompatible with the amorphous polyester resin is confirmed by the following method.

A pulverized amorphous polyester resin and a sample obtained by adding the resin particle in an amount of 20 mass % based on the resin are prepared and melted/mixed for 10 minutes or more by heating each at 200° C. or more, and a disk of about 5 mm in thickness is formed therefrom, allowed to cool and checked for its transparency.

Furthermore, each of these samples is pulverized in a mortar or the like and by performing a thermal analysis measurement using differential scanning calorimetry (DSC) based on K 7121-1987, the extrapolated glass transition initiation temperature (Tg) of the amorphous polyester resin is determined.

In the test above, when the transparency of the formed disk is decreased due to mixing of the particle and the change in Tg of the amorphous polyester resin between before and after mixing stays within Δ±1° C. or less, the resin particle is judged as “incompatible”.

The incompatible resin particle includes a vinyl-based resin particle, an unsaturated polyester particle having a crosslinked surface layer, a silicon resin particle, and the like. Among these, a vinyl-based resin particle is preferred in view of hydrophilicity/hydrophobicity, encapsulation in toner, and easy control of thermal properties of particle.

The monomer component for use in the resin constituting the vinyl-based resin particle used as the incompatible resin particle includes a styrene-based monomer, for example, styrene, an alkyl-substituted styrene (such as a-methylstyrene, vinylnaphthalene, 2-methylstyrene, 3-methylstyrene, 4-methylstyrene, 2-ethylstyrene, 3-ethylstyrene and 4-ethylstyrene), a halogen-substituted styrene (such as 2-chlorostyrene, 3-chlorostyrene and 4-chlorostyrene), and divinylbenzene; and a (meth)acrylic monomer, for example, an alkyl(meth)acrylate such as methyl(meth)acrylate, ethyl(meth)acrylate, propyl(meth)acrylate, butyl(meth)acrylate and 2-carboxyethyl acrylate, a hydroxyethyl(meth)acrylate, a hydroxybutyl(meth)acrylate, an alkyloxyoligoethylene glycol(meth)acrylate such as tetraethylene glycol monomethyl ether(meth)acrylate, a mono-terminated (meth)acrylate of polyethylene glycol, a (meth)acrylic acid, and an N,N-dialkylamino(meth)acrylate,

Among these, styrene, methyl methacrylate, 2-carboxyethyl acrylate, (meth)aerylic acid, butyl(meth)acrylate and the like are preferred, and styrene, methyl methacrylate, 2-carboxyethyl acrylate, butyl(meth)acrylate and the like are more preferred.

In the case where the incompatible resin particle used in the first exemplary embodiment of the present invention is a vinyl-based resin particle, the vinyl-based resin particle may be crosslinked. For crosslinking the vinyl-based resin particle, a crosslinking agent may be used at least as a part of monomer components used in the resin constituting the vinyl-based resin particle.

The crosslinking agent used in the first exemplary embodiment of the present invention includes, for example, aromatic multivinyl compounds such as divinylbenzene and divinylnaphthalene; multivinyl esters of aromatic polyvalent carboxylic acid, such as divinyl phthalate, divinyl isophthalate, divinyl terephthalate, divinyl homophthalate, divinyl/trivinyl trimesate, divinyl naphthalenedicarboxylate and divinyl biphenylcarboxylate; divinyl esters of nitrogen-containing aromatic compound, such as divinyl pyridinediearboxylate; (meth)acrylic acid esters of branched, substituted polyhydric alcohol, such as neopentyl glycol dimethacrylate and 2-hydroxy-1,3-diacryloxypropane; polyethylene glycol di(meth)acrylate, polypropylene-polyethylene glycol di(meth)acrylates; and multivinyl esters of polyvalent carboxylic acid, such as divinyl succinate, divinyl fumarate, divinyl maleate, divinyl diglycolate, divinyl itaconate, divinyl acetonedicarboxylate, divinyl glutarate, divinyl 3,3′-thiodipropionate, divinyl/trivinyl trans-aconitate, divinyl adipate, divinyl pimelate, divinyl suberate, divinyl azelate, divinyl sebacate, divinyl dodecanedioate and divinyl brassylate.

In the case where the crosslinking is used at least as a part of monomer components, the percentage of the crosslinking agent in all monomer components is preferably from 0 mass % to 20 mass %, more preferably from 0 mass % to 5 mass %.

The “(meth)acrylic” as used herein means to encompass both “acrylic” and “methacrylic”. The “(meth)acrylate” means to encompass both “acrylate” and “methacrylate”.

In the case where the monomer component for use in the resin constituting the vinyl-based resin particle used as the incompatible resin particle contains styrene, the percentage of styrene in all monomer components is preferably from 20 mass % to 80 mass %, more preferably from 40 mass % to 70 mass %.

The volume average particle diameter of the incompatible resin particle is preferably from 50 nm to 300 nm, more preferably from 85 nm to 160 nm.

The volume average particle diameter of the incompatible resin particle contained in the toner particle is determined by drawing a cumulative volume distribution from the small diameter side for divided particle size ranges (channels) based on a particle size distribution obtained by measurement with a laser diffraction particle size distribution meter (for example, LA-700, manufactured by Horiba, Ltd.) and taking the particle size at an accumulation of 50% relative to all particles as the volume average particle diameter D50v.

The content of the incompatible resin particle is preferably from 5 mass % to 35 mass %, more preferably from 10 mass % to 25 mass %, based on the entire toner particle.

An incompatible resin particle produced through an emulsion polymerization method, a seed polymerization method, a high-temperature high-pressure emulsification method or the like may also be used.

For example, in the case of applying an emulsion polymerization method to the production of incompatible resin particle, the incompatible resin particle can be obtained by adding monomer components such as styrene-based monomer and (meth)acrylic monomer to water having dissolved therein a water-soluble polymerization initiator such as potassium persulfate and ammonium persulfate, further adding a surfactant such as sodium dodecylsulfate and diphenyloxide disulfonic acid salts, if desired, and heating the mixture with, stirring to perform the polymerization.

Whether or not the incompatible resin particle is contained in the toner according to the first exemplary embodiment of the present invention can be confirmed by the following method.

A toner slice produced for STEM observation is electron-stained with ruthenium tetroxide and observed by STEM, and when the styrene concentration of the incompatible resin particle differs from the toner binder resin, the degree of staining and in turn, the contrast in STEM image differ, whereby the presence of the resin particle can be confirmed. Also, wax and a fixing aid are not stained and have a non-rounded cross-sectional shape and therefore, these can be differentiated from the incompatible resin particle,

### —Coloring Agent—

The coloring agent includes, for example, various pigments such as carbon black, Chrome Yellow, Hansa Yellow, Benzidine Yellow, Threne Yellow, Quinoline Yellow, Pigment Yellow, Peinianent Orange GTR, Pyrazolone Orange, Vulcan Orange, Watchung Red, Permanent Red, Brilliant Carmine 3B, Brilliant Carmine 6B, DuPont Oil Red, Pyrazolone Red, Lithol Red, Rhodamine B Lake, Lake Red C, Rose Bengal, Aniline Blue, Ultramarine Blue, Calco Oil Blue, Methylene Blue Chloride, Phthalocyanine Blue, Pigment Blue, Phthalocyanine Green and Malachite Green Oxalate; and various dyes such as acridine type, xanthene type, azo type, benzoquinone type, azine type, anthraquinone type, thioindigo type, dioxazine type, thiazine type, azomethine type, indigo type, phthalocyanine type, aniline black type, polymethine type, triphenylmethane type, diphenylmethane type and thiazole type.

One of these coloring agents may be used alone, or two or more thereof may be used in combination

A surface-treated coloring agent may also be used, if desired, or the coloring agent may be used in combination with a dispersant. In addition, a plurality of kinds of coloring agents may be used in combination.

The content of the coloring agent is, for example, preferably from 1 mass % to 30 mass %, more preferably from 3 mass % to 15 mass %, based on the entire toner particle.

### —Release Agent—

The release agent includes, for example, a hydrocarbon-based wax; a natural wax such as carnauba wax, rice wax and candelilla wax; a synthetic or mineral/petroleum wax such as montan wax; and an ester-based wax such as fatty acid ester and a montanoic acid ester. The release agent is not limited to these.

The melting temperature of the release agent is preferably from 50° C. to 110° C., more preferably from 60° C. to 100° C.

Incidentally, the melting temperature is determined from a DSC curve obtained by differential scanning calorimetry (DSC), as the “melting peak temperature” described in the determination method of melting temperature of JIS K7121-1987, “Method for Measuring Transition Temperature of Plastics”.

The content of the release agent is, for example, preferably from 1 mass % to 20 mass %, more preferably from 5 mass % to 15 mass %, based on the entire toner particle.

### —Other Additives—

Other additives include, for example, known additives such as magnetic material, charge controlling agent and inorganic powder. These additives are contained as an internal additive in the toner particle.

### —Properties, etc. of Toner Particle—

The toner particle may be a toner particle having a single layer structure or may be a toner particle having a so-called core/shell structure consisting of a core part (core particle) and a coating layer (shell layer) covering the core part.

Here, the toner particle having a core/shell structure preferably consists of, for example, a core part containing a binder resin and, if desired, other additives such as coloring agent and release agent, and a coating layer containing a binder resin,

In the toner according to the first exemplary embodiment of the present invention, the surface layer part contains a crosslinking product of an amorphous unsaturated polyester resin. The toner containing a toner particle and, if desired, an external additive according to an exemplary embodiment of the present invention has a configuration where the surface layer part of the toner particle contains a crosslinking product of an amorphous unsaturated polyester resin.

Whether or not the toner (toner particle) according to the first exemplary embodiment of the present invention contains a crosslinking product is confirmed by the following method.

To 2 g of the toner or toner particle, 100 mL of dimethylsulfoxide and 10 mL of a 5 mol/L sodium hydroxide-methanol solution were added to disperse the toner or toner particle, and a hydrolysis reaction is allowed to proceed at room temperature (for example, 25° C.) for 12 hours. After the reaction, the reaction solution is neutralized with concentrated hydrochloric acid, dimethylformamide is then added to prepare a 0.5 mass % solution, and the molecular weight (number average molecular weight) of the toner dispersion liquid after the hydrolysis treatment is measured by GPC. In the case where a crosslinking product is contained in the toner or toner particle, a gentle peak appears in the region of a number average molecular eight of 3,000 or more. This peak is derived from a crosslinking product of an amorphous unsaturated polyester resin, which is formed by the polymerization reaction of an ethylenically unsaturated bond contained in the molecule of the amorphous unsaturated polyester resin. Whether or not the toner (toner particle) according to an exemplary embodiment of the present invention contains a crosslinking product is determined by the presence or absence of a gentle peak in the ration of a number average molecular weight of 3,000 or more.

Also, whether or not a crosslinking product is contained in the toner (toner particle) according to the first exemplary embodiment of the present invention is confirmed by the following method.

C-K shell NEXAFS (Near Edge X-Ray Absorption Fine Structure) spectra of the surface layer part and center part of the toner are obtained by STXM (Scanning Transmission X-ray Microscope), and a peak area is obtained by subtracting the background at 288 eV and 290 eV with respect to a peak near 288.7 eV derived from an ethylenically unsaturated bond. This peak area is taken as C2p peak, and the C2p peaks of the surface layer part and center part of the toner are determined, whereby the abundance ratio of ethylenically unsaturated bond between the surface layer part and the center part can be determined.

As a result of comparison, when the C2p peak of the surface layer part of the toner is decreased relative to the center part, the surface layer part of the toner particle can be judged as containing a crosslinking product.

The volume average particle diameter (D50v) of the toner particle is preferably from 2 μm to 10 μm, more preferably from 4 μm to 8 μm.

Incidentally, various average particle diameters f the toner particle and various particle size distribution indices are measured using Coulter Multisizer-II (manufactured by Beckman Coulter Co.) and the measurement is performed using ISOTON-II (produced by Beckman Coulter Co.) as the electrolytic solution.

In the measurement, from 0.5 mg to 50 mg of a measurement sample is added to 2 ml of an aqueous 5% solution of a surfactant (sodium dodecylbenzenesulfonate) as a dispersant, and this solution is added to from 100 ml to 150 ml of the electrolytic solution.

The electrolytic solution having suspended therein the measurement sample is subjected to a dispersion treatment in an ultrasonic dispersing machine for 1 minute, and the particle size distribution of particles having a particle diameter of 2 μm to 60 μm is measured by Coulter Multisizer-II by using an aperture having an aperture diameter of 100 μm. The number of particles sampled is 50,000.

A cumulative distribution of each of volume and number is drawn from the small diameter side for divided particle size ranges (channels) based on the particle size distribution measured. The particle diameters at an accumulation of 16% are defined as volume particle diameter D16v and number particle diameter D16p, the particle diameters at an accumulation of 50% are defined as volume average particle diameter D50v and cumulative number average particle diameter D50p, and the particle diameters at an accumulation of 84% are defined as volume particle diameter D84v and number particle diameter D84p.

Using these values, the volume average particle size distribution index (GSDv) is calculated as (D84v/D16v)^{1/2}, and the number average particle size distribution index (GSDp) is calculated as (D84p/D16p)^{1/2}.

The shape factor SF1 of the toner particle is preferably from 110 to 150, more preferably from 120 to 140.

Incidentally, the shape factor SF1 is determined by the following formula:

Formula: SF1=(ML²/A)×(π/4)×100

wherein ML represents the absolute maximum length of the toner, and A represents the projected area of the toner.

Specifically, mainly a microscope image or scanning electron microscope (SEM) image is numerically expressed by the analysis using an image analyzer and used for calculation as follows. That is, an optical microscope image of particles scattered on the surface of a slide glass is taken into a Luzex image analyzer through a video camera, the maximum length and projected area of 100 particles are measured, and after calculation by the formula above, the average value is determined, whereby the shape factor SF1 is obtained.

### (External Additive)

The external additive includes, for example, an inorganic particle. The inorganic particle includes SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, MgSO₄, and the like.

The surface of the inorganic particle as an external additive is preferably subjected to a hydrophobization treatment. The hydrophobization treatment is performed, for example, by immersing the inorganic particle in a hydrophobization treating agent. The hydrophobization treating agent is not particularly limited but includes, for example, a silane-based coupling agent, a silicone oil, a titanate-based coupling agent, and an aluminum-based coupling agent. One of these compounds may be used alone, or two or more thereof may be used in combination.

The amount of the hydrophobization treating agent is usually, for example, from 1 part by mass to 10 parts by mass per 100 parts by mass of the inorganic particle.

The external additive also includes a resin particle (a resin particle of polystyrene, PMMA (polymethyl methacrylate), melamine resins and the like), a cleaning activator (for example, a metal salt of a higher fatty acid typified by zinc stearate, and a particle of a fluorine-based polymer having a high molecular weight), and the like.

The externally added amount of the external additive is, for example, preferably from 0.01 mass % to 5 mass %, more preferably from 0.01 mass % to 2.0 mass %, based on the toner particle.

The toner particle may be prepared by either a dry production method (for example, a kneading-pulverization method) or a wet production method (for example, an aggregation/coalescence method, a suspension polymerization method, and a dissolution-suspension method). The production method of the toner particle is not particularly limited to these production methods, and a known production method is employed.

Among others, the toner particle is preferably obtained by an aggregation/coalescence method.

Specifically, for example, in the case of producing the toner particle by an aggregation/coalescence method, the toner particle is produced through a step of preparing a resin particle dispersion liquid having dispersed therein a resin particle working out to a binder resin (a resin particle dispersion liquid preparing step), a step of preparing an incompatible resin particle dispersion liquid having dispersed therein a resin particle incompatible with an amorphous polyester resin (an incompatible resin particle dispersion liquid preparing step), a step of aggregating the resin particle and the incompatible resin particle (if desired, other particles) in the resin particle dispersion liquid (in a dispersion liquid after other particle dispersion liquids are mixed, if desired) to form an aggregated particle (an aggregated particle forming step), and a step of heating the aggregated particle dispersion liquid having dispersed therein the aggregated particle and thereby fusing/coalescing aggregated particles to form a toner particle (a fusion/coalescing step).

In the production of the toner particle, a crosslinking step of crosslinking an amorphous unsaturated polyester resin present in the surface layer part of the toner particle, or an adhesion step of attaching a resin particle containing a crosslinking product of an amorphous unsaturated polyester resin to the surface of the toner particle, may be performed so that the surface layer of the toner particle can contain a crosslinking product of an amorphous unsaturated polyester resin.

In the crosslinking step, for example, after the fusion/coalescing step, a polymerization initiator may be added to a toner particle dispersion liquid containing the toner particle before crosslinking, to polymerize an amorphous unsaturated polyester resin present in the surface of the toner particle and thereby form a crosslinking product of an amorphous unsaturated polyester resin in the surface of the toner particle.

On the other hand, in the adhesion step, for example, a step of forming the later-described second aggregated particle by using a resin particle dispersion liquid containing a crosslinked particle resulting from crosslinking of an amorphous unsaturated polyester resin may be performed to thereby attach a resin particle containing a crosslinking product of an amorphous unsaturated polyester resin to the surface of the toner particle.

The surface layer of the toner according to an exemplary embodiment of the present invention may be configured to contain a crosslinking product of an amorphous unsaturated polyester resin by performing the above-described crosslinking step or adhesion step,

Incidentally, in the case of producing the toner particle by a kneading-pulverization method, a crosslinking product of an amorphous unsaturated polyester resin may be formed in the surface of the toner particle by dispersing the toner particle produced by a kneading-pulverization method in an aqueous medium, adding a polymerization initiator to the medium, and polymerizing an amorphous unsaturated polyester resin present in the surface of the toner particle.

Each step is described in detail below.

In the following, a method for obtaining a toner particle containing a coloring agent and a release agent is described, but a coloring agent and a release agent are additives used, if desired. Of course, additives other than a coloring agent and release agent may also be used.

### —Resin Particle Dispersion Liquid Preparing Step—

First, as well as a resin particle dispersion liquid having dispersed therein a resin particle working out to a binder resin, for example, a coloring agent particle dispersion liquid having dispersed therein a coloring agent particle, and a release agent dispersion liquid having dispersed therein a release agent particle are prepared.

Here, the resin particle dispersion liquid is prepared, for example, by dispersing a resin particle in a dispersion medium with the aid of a surfactant.

The dispersion medium for use in the resin particle dispersion liquid includes, for example, an aqueous medium.

The aqueous medium includes, for example, water such as distilled water and ion-exchanged water, and alcohols. One of these may be used alone, or two or more thereof may be used in combination.

The surfactant includes, for example, an anionic surfactant such as sulfate salt type, sulfonate salt type, phosphoric acid ester type and soap type; a cationic surfactant such as amine salt type and quaternary ammonium salt type; and a nonionic surfactant such as polyethylene glycol type, alkylphenol ethylene oxide adduct type and polyhydric alcohol type. Among these, an anionic surfactant and a cationic surfactant are preferred. The nonionic surfactant may be used in combination with an anionic surfactant or a cationic surfactant.

One surfactant may be used alone, or two or more surfactants may be used in combination.

In the resin particle dispersion liquid, the method for dispersing the resin particle in a dispersion medium includes, for example, a rotation shearing homogenizer and a general dispersing method using media, such as ball mill, sand mill and dynomill. Also, depending on the kind of the resin particle, the resin particle may be dispersed in the resin particle dispersion liquid by using, for example, a phase inversion emulsification method.

Incidentally, the phase inversion emulsification method is a method of dissolving a resin to be dispersed, in a hydrophobic organic solvent in which the resin is soluble, adding a base to a continuous organic phase (O phase) to cause neutralization, and then charging an aqueous medium (W phase) to invert the resin from W/O to O/W (so-called phase inversion) and make a discontinuous phase, thereby dispersing the resin as particles in the aqueous medium.

The volume average particle diameter of the resin particle dispersed in the resin particle dispersion liquid is, for example, preferably from 0.01 μm to 1 μm, more preferably from 0.08 μm to 0.8 μm, still more preferably from 0.1 μm to 0.6 μm.

The volume average particle diameter of the resin particle is determined by drawing a cumulative volume distribution from the small diameter side for divided particle size ranges (channels) based on a particle size distribution obtained by measurement with a laser diffraction particle size distribution meter (for example, LA-700, manufactured by Horiba, Ltd.) and taking the particle size at an accumulation of 50% relative to all particles as the volume average particle diameter D50v. Incidentally, the volume average particle diameter of particles in other dispersion liquids is measured in the same manner.

The content of the resin particle contained in the resin particle dispersion liquid is, for example, preferably from 5 mass % to 50 mass %, more preferably from 10 mass % to 40 mass %.

Similarly to the resin particle dispersion, for example, a coloring agent dispersion liquid, a release agent dispersion liquid, and an incompatible resin particle dispersion liquid are also prepared, That is, with respect to the volume average particle diameter of particles, the dispersion medium, the dispersion method and the content of the particle in the resin particle dispersion, the same applies to the coloring agent particle dispersed in the coloring agent dispersion liquid, the release agent particle dispersed in the release agent dispersion liquid, and the incompatible resin particle dispersed in the incompatible resin particle dispersion liquid.

Also, the incompatible resin particle dispersion liquid may be prepared by an emulsion polymerization method.

### —Aggregated Particle Forming Step—

Next, an incompatible resin particle dispersion liquid, a coloring agent particle dispersion liquid and a release agent dispersion liquid are mixed together with the resin particle dispersion liquid.

In the mixed dispersion liquid, a resin particle, a coloring agent particle, a release agent particle and an incompatible resin particle are hetero-aggregated to form an aggregated particle having a diameter close to the diameter of a toner particle and containing a resin particle, a coloring agent particle, a release agent particle and an incompatible resin particle.

Specifically, for example, as well as adding a coagulant to the mixed dispersion liquid, the mixed dispersion liquid is adjusted to acidic pH (for example, a pH of 2 to 5) and after adding, if desired, a dispersion stabilizer, heated at a temperature of glass transition temperature of the resin particle (specifically, for example, from glass transition temperature of resin particle—30° C. to glass transition temperature—10° C.) to aggregate particles dispersed in the mixed dispersion liquid and form an aggregated particle.

In the aggregated particle forming step, for example, the coagulant above may be added at room temperature (for example, 25° C.) while stirring the mixed dispersion liquid by a rotation shearing homogenizer and after adjusting the mixed dispersion liquid to acidic pH (for example, a pH of 2 to 5) and adding, if desired, a dispersion stabilizer, the above-described heating may be performed.

The coagulant includes, for example, a surfactant having polarity reverse to that of the surfactant used as a dispersant added to the mixed dispersion liquid, such as inorganic metal salt and divalent or higher valent metal complex. In particular, when a metal complex is used as the coagulant, the amount of the surfactant used is decreased, and the charging properties are enhanced.

An additive forming a complex or similar bond with a metal ion of the coagulant may be used, if desired. As this additive, a chelating agent is preferably used.

The inorganic metal salt includes, for example, a metal salt such as calcium chloride, calcium nitrate, barium chloride, magnesium chloride, zinc chloride, aluminum chloride and aluminum sulfate, and an inorganic metal salt polymer such as polyaluminum chloride, polyaluminum hydroxide and calcium polysulfide.

As the chelating agent, a water-soluble chelating agent may also be used. The chelating agent includes, for example, an oxycarboxylic acid such as tartaric acid, citric acid and gluconic acid, an iminodiacetic acid (IDA), a nitrilotriacetic acid (NTA), and an ethylenediaminetetraacetic acid (EDTA).

The amount of the chelating agent added is preferably from 0.01 parts by mass to 5.0 parts by mass, more preferably from 0.1 parts by mass to less than 3.0 parts by mass, per 100 parts by mass of the resin particle.

### —Fusion/Coalescing Step—

Next, the aggregated particle dispersion liquid having dispersed therein an aggregated particle is heated, for example, at not less than the glass transition temperature of the resin particle (for example, not less than a temperature higher by 10° C. to 30° C. than the glass transition temperature of the resin particle) to fuse/coalesce the aggregated particles and form a toner particle.

The toner particle is obtained through these steps.

Incidentally, the toner particle may also be produced through, after the aggregated particle dispersion liquid having dispersed therein an aggregated particle is obtained, a step of further mixing and aggregating the aggregated particle dispersion liquid and the resin particle dispersion liquid having dispersed therein a resin particle to further attach a resin particle to the surface of the aggregated particle and thereby form a second aggregated particle, and a step of heating the second aggregated particle dispersion liquid having dispersed therein a second aggregated particle to fuse/coalesce second aggregated particles and form a toner particle having a core/shell structure.

After the completion of fusion/coalescing step, the above-described crosslinking step is performed, if desired, and the toner particle formed in a solution is subjected to known washing step, solid-liquid separation step and drying step to obtain a dry toner particle.

In the washing step, full displacement washing with ion exchanged water is preferably performed in view of chargeability. Also, the solid-liquid separation step is not particularly limited, but in view of productivity, suction filtration, pressure filtration, or the like is preferably performed. In addition, the drying step is also not particularly limited in its method, but in view of productivity, freeze drying, flash jet drying, fluidized drying, vibration-type fluidized drying, or the like is preferably performed.

The polymerization initiator used in the crosslinking step is not particularly limited.

The polymerization initiator for use in the first exemplary embodiment of the present invention includes, for example, as a water-soluble polymerization initiator, peroxides such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, tert-butyl hydroperoxide pertriphenylacetate, tert-butyl performate, tert-butyl peracetate, tert-butyl perbenzoate, tert-butyl perphenylacetate, tert-butyl permethoxyacetate, Cert-butyl per-N-(3-toluoyl)carbamate, ammonium bisulfate and sodium bisulfate, but the present invention is not limited thereto.

Also, the oil-soluble polymerization initiator includes, for example, an azo-based polymerization initiator such as 2,2′-azobisisobutyronitrile, 2,2′-azobis(2,4-dimethylvaleronitrile), 1,1′-azobis(cyclohexane-1-carbonitrile), and 2,2′-azobis-4-methoxy-2,4-dimethylvaleronitrile.

The toner according to the first exemplary embodiment of the present invention is produced, for example, by adding an external additive to the obtained dry toner particle and mixing them. The mixing is preferably perfoiuied, for example, by a V-blender, a Henschel mixer, or a Lodige mixer. Furthermore, if desired, coarse toner particles may be removed using a vibration sieving machine, a wind power sieving machine, or the like.

Next, the electrostatic image-developing toner according to a second exemplary embodiment of the present invention (hereinafter, sometimes simply referred to as “toner”).

The electrostatic image-developing toner according to the second exemplary embodiment of the present invention (hereinafter, sometimes simply referred to as “toner”) contains an amorphous polyester resin and a crystalline polyester resin, wherein the amorphous polyester resin contains an amorphous polyester resin having an ethylenically unsaturated bond, the surface layer part contains a crosslinking product of the amorphous polyester resin having an ethylenically unsaturated bond, the maximum value of tan & is present in the range of 50° C. to 70° C., the maximum value of tan 8 is 1 or more, and the average gradient of the tan δ value relative to the temperature in the range between a temperature lower by 10° C. and a temperature lower by 4° C., than the temperature exhibiting the maximum value of tan δ, is 0.10° C.⁻¹ or more.

Conventionally, in order to achieve a low-temperature fixing property of a toner, a crystalline resin such as crystalline polyester resin is sometimes used as a fixing aid. The low-temperature fixing property can be attained by incorporating a crystalline polyester resin into the toner. However, in a fanless machine (a printer or copier having no cooling fan mechanism) which is being developed similarly in view of energy saving and environmental protection, when printing is performed continuously, the in-machine temperature rises and in turn, the temperature of a recording medium ejected after fixing a toner image on the recording medium becomes high, leaving the possibility that when recording mediums having a fixed toner image are stacked before cooling of the recording medium, the toner image is sometimes back-transferred onto the recording medium.

The toner according to the second exemplary embodiment of the present invention ensures that when recording mediums each having a fixed toner image are stacked after the fixing of toner image on the recording medium but before the cooling of recording medium, back transfer of the toner image onto the recording medium is suppressed. The reason therefor is not clearly known but is presumed as follows.

The tan δ of a toner is one of indices indicating the physical property of the toner at the temperature when measuring the tan δ. When tan δ is 1 or more, the physical property of the toner becomes viscosity-dominated, and when tan δ is 1 or less, the physical property of the toner becomes elasticity-dominated. Also, the temperature exhibiting the maximum value of tan δ of the toner is one of indices indicating the glass transition temperature of the toner. When the average gradient of the tan δ value relative to the temperature in the range between a temperature lower by 10° C. and a temperature lower by 4° C., than the temperature exhibiting the maximum value of tan δ, is 0.10° C.⁻¹ or more, in the course of the recording medium cooling after the fixing of toner image, it is considered that the temperature range where the physical property of the toner is converted from viscosity-dominated to elasticity-dominated is small and therefore, the toner physical property that has been viscous is likely to swiftly become elastic. Furthermore, the surface layer part of the toner according to the second exemplary embodiment of the present invention contains a crosslinking product of an amorphous polyester resin having an ethylenically unsaturated bond, and the presence of this crosslinking product is considered to facilitate conversion of the toner physical property to being elastic. Because of the toner physical property converted to being elastic, the back transfer of toner image onto a recording medium is considered to be suppressed.

The toner according to the second exemplary embodiment of the present invention is described in detail below.

The toner according to the second exemplary embodiment of the present invention is configured to contain a toner particle and, if desired, an external additive.

### (Toner Particle)

The toner particle is configured to contain, for example, a binder resin and, if desired, contain a coloring agent, a release agent and other additives.

—Binder Resin—In the second exemplary embodiment of the present invention, an amorphous polyester resin and a crystalline polyester resin are used in combination as the binder resin. The amorphous polyester resin contains an amorphous polyester resin having an ethylenically unsaturated bond (hereinafter, sometimes referred to as an amorphous unsaturated polyester resin). In the second exemplary embodiment of the present invention, the amorphous unsaturated polyester resin is used at least as a part of the amorphous polyester resin. Incidentally, in the second exemplary embodiment of the present invention, for the sake of distinction from the amorphous unsaturated polyester resin, an amorphous polyester resin having no ethylenically unsaturated bond or having an ethylenically unsaturated bond where, however, the bond does not have reactivity, is sometimes referred to as an amorphous saturated polyester resin.

Incidentally, the “crystalline” of the resin means to have a definite endothermic peak, not a stepwise change of endothermic heat quantity, in the differential scanning calorimetry (DSC), and specifically indicates that the half-value width of the endothermic peak when measured at a temperature rise rate of 10 (° C./min) is within 10° C.

On the other hand, the “amorphous” of the resin indicates that the half-value width exceeds 10° C. or a stepwise change in the endothermic peak or no definite endothermic peak is observed.

Amorphous Saturated Polyester Resin

The amorphous saturated polyester resin is same as the amorphous saturated polyester resin in the first exemplary embodiment above.

Crystalline Polyester Resin

The crystalline polyester resin includes, for example, a polycondensate of a polyvalent carboxylic acid and a polyhydric alcohol. Incidentally, as the crystalline polyester resin, a commercially available product may be used, or a synthesized resin may be used.

Here, the crystalline polyester resin is preferably a polycondensate using a polymerizable monomer having a linear aliphatic component rather than a polymerizable monomer having an aromatic component, because a crystal structure is easily formed.

The polyvalent carboxylic acid includes, for example, an aliphatic dicarboxylic acid (such as fumaric acid, oxalic acid, succinic acid, glutaric acid, adipic acid, suberic acid, azelaic acid, sebacic acid, 1,9-nonane dicarboxylic acid, 1,10-decane dicarboxylic acid, 1,12-dodecanedicarboxylic acid, 1,14-tetradecanedicarboxylic acid and 1,18-octadecanedicarboxylic acid), an aromatic dicarboxylic acid (for example, a dibasic acid such as phthalic acid, isophthalic acid, terephthalic acid and naphthalene-2,6-dicarboxylic acid), an anhydride thereof, and a lower (for example, a carbon number of 1 to 5) alkyl ester thereof.

As the polyvalent carboxylic acid, together with the dicarboxylic acid, a trivalent or higher valent carboxylic acid having a crosslinked structure or a branched structure may be used in combination. The trivalent carboxylic acid includes, for example, an aromatic carboxylic acid (such as 1,2,3-benzene tricarboxylic acid, 1,2,4-benzene tricarboxylic acid and 1,2,4-naphthalene tricarboxylic acid), an anhydride thereof, and a lower (for example, a carbon number of 1 to 5) alkyl ester thereof.

As the polyvalent carboxylic acid, together with these dicarboxylic acids, a sulfonic acid group-containing dicarboxylic acid or an ethylenic double bond-containing dicarboxylic acid may be used in combination.

One of these polyvalent carboxylic acids may be used alone, or two or more thereof may be used in combination.

In the second exemplary embodiment of the present invention, the percentage of the fumaric acid-derived structural unit in the total amount of structural units derived from carboxylic acid components constituting the crystalline polyester resin is preferably 30 mol % or more, more preferably 60 mol % or more, still more preferably 70 mol % or more. Above all, it is preferred to substantially not contain structural units derived from carboxylic acid components other than the fumaric acid-derived structural unit, and the percentage of the fumaric acid-derived structural unit in the total amount of structural units derived from carboxylic acid components constituting the crystalline polyester resin is preferably 100 mol %.

The polyhydric alcohol includes, for example, an aliphatic diol (for example, a linear aliphatic diol with the main chain moiety having a carbon number of 7 to 20). The aliphatic dial includes, for example, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these aliphatic diols, 1,8-octanediol, 1,9-nonanediol and 1,10-decanediol are preferred.

As the polyhydric alcohol, together with the diol, a trihydric or higher alcohol having a crosslinked structure or a branched structure may be used in combination. The trihydric or higher alcohol includes, for example, glycerin, trimethylolethane, trimethylolpropane, and pentaerythritol.

One of these polyhydric alcohols may be used alone, or two or more thereof may be used in combination.

Here, the content of the aliphatic diol in the polyhydric alcohols is preferably 80 mol % or more, more preferably 90 mol % or more.

The melting temperature of the crystalline polyester resin is preferably 70° C. or more, more preferably 75° C. or more, still more preferably 80° C. or more. Also, the melting temperature of the crystalline polyester resin is preferably 130° C. or less.

Incidentally, the melting temperature is determined from a DSC curve obtained by differential scanning calorimetry (DSC), as the “melting peak temperature” described in the determination method of melting temperature of JIS K7121-1987, “Method for Measuring Transition Temperature of Plastics”.

The weight average molecular weight (Mw) of the crystalline polyester resin is preferably from 6,000 to 35,000.

The crystalline polyester resin is obtained, for example, by a known production method, similarly to the amorphous saturated polyester resin.

Amorphous Unsaturated Polyester Resin

The amorphous unsaturated polyester resin for use in the second exemplary embodiment of the present invention is not particularly limited as long as it is a resin containing, in the molecule, an ethylenically unsaturated bond having reactivity. The reactivity as used in the exemplary embodiment of the present invention indicates that when the resin as a particle of about 200 nm is heated at 80° C. while stirring a 30 mass % water dispersion liquid thereof and reacted for 2 hours by adding a polymerization initiator (APS, produced by Mitsubishi Chemical Corporation) in an amount of 5 mass % based on the resin, the gel content (THF-insoluble content) of the resin particle after solid separation in a freeze dryer is increased by 3 mass % or more between before and after the reaction. Hereinafter, the ethylenically unsaturated bond having reactivity is sometimes simply referred to as an ethylenically unsaturated bond or an unsaturated bond.

The unsaturated bond equivalent of the amorphous unsaturated polyester resin for use in the second exemplary embodiment of the present invention is preferably 4,000 g/eq or less, more preferably 1,500 g/eq or less, still more preferably 1,000 g/eq or less.

In the second exemplary embodiment of the present invention, the unsaturated bond equivalent of the resin indicates the value measured by the following method.

NMR analysis (H analysis) of the resin is performed to identify the monomer species and compositional ratio and by determining the proportion of a monomer having an unsaturated double bond therefrom, the molecular weight per unsaturated bond is calculated.

The amorphous unsaturated polyester resin is an amorphous polyester resin having an ethylenically unsaturated bond (for example, a vinyl group or a vinylene group) in the molecule.

Specifically, the amorphous unsaturated polyester resin is, for example, a condensation polymer of a polyvalent carboxylic acid and a polyhydric alcohol and is preferably a polyester resin where a monomer having an ethylenically unsaturated bond (for example, a vinyl group or a vinylene group) working out to an unsaturated polyester component is used as at least either one member of the polyvalent carboxylic acid and the polyhydric alcohol.

Among others, in view of stability, a condensation polymer of a polyvalent carboxylic acid having an ethylenically unsaturated bond (for example, a vinyl group or a vinylene group) and preferably a polyhydric alcohol is preferred as the amorphous unsaturated polyester resin, and a condensation polymer of a divalent carboxylic acid having an ethylenically unsaturated bond (for example, a vinyl group or a vinylene group) and a dihydric alcohol (namely, a linear polyester resin) is more preferred as the amorphous unsaturated polyester resin.

In the case where the amorphous unsaturated polyester resin is a condensation polymer of an ethylenically unsaturated bond-containing polyvalent carboxylic acid and a polyhydric alcohol, a polyvalent carboxylic acid not having an ethylenically unsaturated bond may be used as a part of the polyvalent carboxylic acid, if desired. Specific examples of the polyvalent carboxylic acid not having an ethylenically unsaturated bond include polyvalent carboxylic acids recited in the paragraph of Amorphous Saturated Polyester Resin.

The divalent carboxylic acid having an ethylenically unsaturated bond (for example, a vinyl group or a vinylene group) includes, for example, a fumaric acid, a maleic acid, a maleic anhydride, a citraconic acid, a mesaconic acid, an itaconic acid, a glutaconic acid, an allylmalonic acid, an acetylenedicarboxylic acid, and a lower (a carbon number of 1 to 4) alkyl ester thereof. In view of reactivity, the ethylenically unsaturated bond is preferably located in the main chain of a polyester formed by condensation or in a portion close to the main chain. A monomer such as alkenylsuccinic acid having an unsaturated bond in a side chain remote from the main chain is poor in the reactivity and is not treated here as a polyvalent carboxylic acid having an unsaturated bond.

The trivalent or higher valent carboxylic acid having an ethylenically unsaturated bond (for example, a vinyl group or a vinylene group) includes an aconitic acid, a 3-butene-1,2,3-tricarboxylic acid, a 4-pentene-1,2,4-tricarboxylic acid, a 1-pentene-1,1,4,4,-tetracarboxylic acid, and a lower (a carbon number of 1 to 4) alkyl ester thereof

One of these polyvalent carboxylic acids may be used alone, or two or more thereof may be used in combination.

The dihydric alcohol includes, for example, bisphenol A, hydrogenated bisphenol A, an ethylene oxide or propylene oxide adduct of bisphenol A, 1,4-cyclohexanediol, 1,4-cyclohexanedimethanol, ethylene glycol, diethylene glycol, propylene glycol, dipropylene glycol, 1,3-butanediol, 1,4-butanediol, 1,5-pentanediol, 1,6-hexanediol, 1,9-nonanediol, and neopentyl glycol

The trihydric or higher alcohol includes, for example, glycerin, trimethylolethane, trimethylolpropane, and pentaerythritol.

Incidentally, together with the polyhydric alcohol, a monovalent acid such as acetic acid and benzoic acid, or a monohydric alcohol such as cyclohexanol and benzyl alcohol may be used in combination, if desired, for the purpose of, for example, adjusting the acid value or hydroxyl group value.

One of these polyhydric alcohols may be used alone, or two or more thereof may be used in combination.

Among these amorphous unsaturated polyester resins that are a condensation polymer of a polyvalent carboxylic acid and a polyhydric alcohol, a condensation polymer of at least one divalent carboxylic acid selected from a fumaric acid, a maleic acid and a maleic anhydride, and a dihydric alcohol is preferred from the standpoint of reactivity to an ethylenically unsaturated bond.

That is, the unsaturated polyester component of the amorphous unsaturated polyester resin is preferably a component derived from at least one divalent carboxylic acid selected from a fumaric acid, a maleic acid and a maleic anhydride.

The percentage of the ethylenically unsaturated bond-containing monomer in the total of a polyvalent carboxylic acid and a polyhydric alcohol constituting the amorphous unsaturated polyester resin is preferably from 5 mol % to 25 mol %, more preferably from 7.5 mol % to 22.5 mol %.

The production method of the amorphous unsaturated polyester resin is not particularly limited, and a method in accordance with the above-described method for the amorphous saturated polyester resin may be used.

The weight average molecular weight (Mw) of the amorphous unsaturated polyester resin is, for example, preferably from 30,000 to 300,000, more preferably from 30,000 to 200,000, still more preferably from 35,000 to 150,000.

The glass transition temperature (Tg) of the amorphous unsaturated polyester resin is, for example, preferably from 50° C. to 80° C., more preferably from 50° C. to 65° C.

Incidentally, the glass transition temperature of the amorphous unsaturated polyester resin is determined as the peak temperature of endothermic peak obtained by differential scanning calorimetry (DSC).

The content of the binder resin is, for example, preferably from 40 mass % to 95 mass %, more preferably from 50 mass % to 90 mass %, still more preferably from 60 mass % to 85 mass %, based on the entire toner particle.

As for the percentage of the crystalline polyester resin in the entire binder resin, the content of the crystalline polyester resin used is preferably from 2 mass % to 40 mass % (preferably from 2 mass % to 20 mass %) based on all binder resins.

As for the percentage of the amorphous unsaturated polyester resin in the entire amorphous polyester resin, the content of the amorphous unsaturated polyester resin used is preferably from 25 mass % to 100 mass % (preferably from 45 mass % to 100 mass %) based on all amorphous polyester resins.

### —Coloring Agent—

The coloring agent includes, for example, various pigments such as carbon black, Chrome Yellow, Hansa Yellow, Benzidine Yellow, Threne Yellow, Quinoline Yellow, Pigment Yellow, Permanent Orange GTR, Pyrazolone Orange, Vulcan Orange, Watchung Red, Permanent Red, Brilliant Carmine 3B, Brilliant Carmine 6B, DuPont Oil Red, Pyrazolone Red, Lithol Red, Rhodamine B Lake, Lake Red C, Rose Bengal, Aniline Blue, Ultramarine Blue, Calco Oil Blue, Methylene Blue Chloride, Phthalocyanine Blue, Pigment Blue, Phthalocyanine Green and Malachite Green Oxalate; and various dyes such as acridine type, xanthene type, azo type, benzoquinone type, azine type, anthraquinone type, thioindigo type, dioxazine type, thiazine type, azomethine type, indigo type, phthalocyanine type, aniline black type, polymethine type, triphenylmethane type, diphenylmethane type and thiazole type.

One of these coloring agents may be used alone, or two or more thereof may be used in combination

A surface-treated coloring agent may also be used, if desired, or the coloring agent may be used in combination with a dispersant. In addition, a plurality of kinds of coloring agents may be used in combination.

The content of the coloring agent is, for example, preferably from 1 mass % to 30 mass %, more preferably from 3 mass % to 15 mass %, based on the entire toner particle.

### —Release Agent—

The release agent includes, for example, a hydrocarbon-based wax; a natural wax such as carnauba wax, rice wax and candelilla wax; a synthetic or mineral/petroleum wax such as montan wax; and an ester-based wax such as fatty acid ester and a montanoic acid ester. The release agent is not limited to these.

The melting temperature of the release agent is preferably from 50° C. to 110° C., more preferably from 60° C. to 100° C.

Incidentally, the melting temperature is determined from a DSC curve obtained by differential scanning calorimetry (DSC), as the “melting peak temperature” described in the determination method of melting temperature of JIS K7121-1987, “Method for Measuring Transition Temperature of Plastics”.

The content of the release agent is, for example, preferably from 1 mass % to 20 mass %, more preferably from 5 mass % to 15 mass %, based on the entire toner particle.

### —Other Additives—

Other additives include, for example, known additives such as magnetic material, charge controlling agent and inorganic powder. These additives are contained as an internal additive in the toner particle.

### —Properties, etc. of Toner Particle—

The toner particle may be a toner particle having a single layer structure or may be a toner particle having a so-called core/shell structure consisting of a core part (core particle) and a coating layer (shell layer) covering the core part.

Here, the toner particle having a core/shell structure preferably consists of for example, a core part containing a binder resin and, if desired, other additives such as coloring agent and release agent, and a coating layer containing a binder resin.

In the toner according to the second exemplary embodiment of the present invention, the surface layer part contains a crosslinking product of an amorphous unsaturated polyester resin. The toner containing a toner particle and, if desired, an external additive according to an exemplary embodiment of the present invention has a configuration where the surface layer part of the toner particle contains a crosslinking product of an amorphous unsaturated polyester resin.

Whether or not the toner (toner particle) according to the second exemplary embodiment of the present invention contains a crosslinking product is confirmed by the following method.

To 2 g of the toner or toner particle, 100 mL of dimethylsulfoxide and 10 mL of a 5 mol/L sodium hydroxide-methanol solution were added to disperse the toner or toner particle, and a hydrolysis reaction is allowed to proceed at room temperature (for example, 25° C.) for 12 hours. After the reaction, the reaction solution is neutralized with concentrated hydrochloric acid, dimethylformamide is then added to prepare a 0.5 mass % solution, and the molecular, weight (number average molecular weight) of the toner dispersion liquid after the hydrolysis treatment is measured by GPC. In the case where a crosslinking product is contained in the toner or toner particle, a gentle peak appears in the region of a number average molecular eight of 3,000 or more. This peak is derived from a crosslinking product of an amorphous unsaturated polyester resin, which is formed by the polymerization reaction of an ethylenically unsaturated bond contained in the molecule of the amorphous unsaturated polyester resin. Whether or not the toner (toner particle) according to an exemplary embodiment of the present invention contains a crosslinking product is determined by the presence or absence of a gentle peak in the ration of a number average molecular weight of 3,000 or more.

Also, whether or not a crosslinking product is contained in the toner (toner particle) according to the second exemplary embodiment of the present invention is confirmed by the following method.

C-K shell NEXAFS (Near Edge X-Ray Absorption. Fine Structure) spectra of the surface layer part and center part of the toner are obtained by STXM (Scanning Transmission X-ray Microscope), and a peak area is obtained by subtracting the background at 288 eV and 290 eV with respect to a peak near 2883 eV derived from an ethylenically unsaturated bond. This peak area is taken as C2p peak, and the C2p peaks of the surface layer part and center part of the toner are determined, whereby the abundance ratio of ethylenically unsaturated bond between the surface layer part and the center part can be determined.

As a result of comparison, when the C2p peak of the surface layer part of the toner is decreased relative to the center part, the surface layer part of the toner (toner particle) can be judged as containing a crosslinking product.

The volume average particle diameter (D50v) of the toner particle is preferably from 2 μm to 10 μm, more preferably from 4 μm to 8 μm.

Incidentally, various average particle diameters f the toner particle and various particle size distribution indices are measured using Coulter Multisizer-II (manufactured by Beckman Coulter Co.) and the measurement is performed using ISOTON-II (produced by Beckman Coulter Co.) as the electrolytic solution.

In the measurement, from 0.5 mg to 50 mg of a measurement sample is added to 2 ml of an aqueous 5% solution of a surfactant (sodium dodecylbenzenesulfonate) as a dispersant, and this solution is added to from 100 ml to 150 ml of the electrolytic solution.

The electrolytic solution having suspended therein the measurement sample is subjected to a dispersion treatment in an ultrasonic dispersing machine for 1 minute, and the particle size distribution of particles having a particle diameter of 2 μm to 60 μm is measured by Coulter Multisizer-II by using an aperture having an aperture diameter of 100 μm. The number of particles sampled is 50,000.

A cumulative distribution of each of volume and number is drawn from the small diameter side for divided particle size ranges (channels) based on the particle size distribution measured. The particle diameters at an accumulation of 16% are defined as volume particle diameter D16v and number particle diameter D16p, the particle diameters at an accumulation of 50% are defined as volume average particle diameter D50v and cumulative number average particle diameter D50p, and the particle diameters at an accumulation of 84% are defined as volume particle diameter D84v and number particle diameter D84p.

Using these values, the volume average particle size distribution index (GSDv) is calculated as (D84v/D16v)^{1/2}, and the number average particle size distribution index (GSDp) is calculated as (D84p/D16p)^{1/2}.

The shape factor SF1 of the toner particle is preferably from 110 to 150, more preferably from 120 to 140.

Incidentally, the shape factor SF1 is determined by the following formula:

Formula: SF1=(ML²/A)×(π/4)×100

wherein ML represents the absolute maximum length of the toner, and A represents the projected area of the toner.

Specifically, mainly a microscope image or scanning electron microscope (SEM) image is numerically expressed by the analysis using an image analyzer and used for calculation as follows. That is, an optical microscope image of particles scattered on the surface of a slide glass is taken into a Luzex image analyzer through a video camera, the maximum length and projected area of 100 particles are measured, and after calculation by the formula above, the average value is determined, whereby the shape factor SF1 is obtained.

In the toner according to the second exemplary embodiment of the present invention, the maximum value of tan δ is present in the range of 50° C. to 70° C. If the maximum value of tan δ is present at less than 50° C., blocking of the toner may occur, whereas if the maximum value is present at more than 70° C., the amount of heat energy necessary for the fixing of toner image is increased, and the low-temperature fixing property may not be achieved.

It may be sufficient if one maximum value of tan δ is present in the range of 50° C. to 70° C. When two or more maximum values of tan 6 are present in the range of 50° C. to 70° C., this means that a plurality of binder resins are contained in the toner and these resins are incompatible with each other. In this case, there may arise a problem that the image formed by the toner is fragile and cannot withstand the practical use. A toner being capable of withstanding the practical use and having two or more maximum values of tan δ in the range of 50° C. to 70° C. is not present.

In the toner according to an exemplary embodiment of the present invention, the maximum value of tan δ is 1 or more, preferably from 1 to 2, more preferably from 1.2 to 1.6, If the maximum value of tan δ is less than 1, the toner is excessively elastic, and a problem of weak adhesion to paper may arise.

In the toner according to the second exemplary embodiment of the present invention, the average gradient of the tan δ value relative to the temperature in the range between a temperature lower by 10° C. and a temperature lower by 4° C., than the temperature exhibiting the maximum value of tan δ, is 0.10° C.⁻¹ or more, preferably 0.12° C.⁻¹ or more, more preferably 0.13° C.⁻¹ or more. If the average gradient of the tan δ value relative to the temperature is less than 0.10° C.⁻¹, the back transfer of toner image onto the recording medium may be less likely to be suppressed.

In the second exemplary embodiment of the present invention, the tan δ (tan Delta: dynamic loss tangent of dynamic viscoelasticity) is defined by G″/G′ after determining the storage modulus G′ and the loss modulus G″ by the measurement of temperature dependency of the dynamic viscoelasticity. Here, G′ is an elastic response component of the modulus in the relationship of stress generated relative to distortion during deformation, and the energy relative to deformation work is stored. The viscous response component of the modulus is G″. Also, tan δ defined by G″/G′ is a measure of the ratio between loss and storage of the energy relative to deformation work.

The storage modulus G′ and the loss modulus G″ can be measured, for example, using a rotating flat plate rheometer (ARES, manufactured by TA Instruments). As an example of the measurement, a temperature rise measurement is performed using a rheometer (ARES rheometer, manufactured by Rheometrie Scientific) and using a parallel plate under the condition of a frequency of 1 [Hz]. A sample is set at approximately from 120 [° C.] to 140 [° C.], cooled to room temperature (30° C. or less), kept at 30° C. for 3 hours, heated at a temperature rise rate of 2 [° C./min], and the storage modulus G′, loss modulus G″ and tan δ during temperature rise are measured every 1 [° C.].

The sample used for the measurement of tan δ is prepared by the following method.

A toner or toner particle to be measured is molded into a tablet shape at ordinary temperature (for example, 25° C.) by using a press molding machine, as a result, a sample having substantially no gap between toner particles can be produced. The measurement of tan δ is performed using this sample.

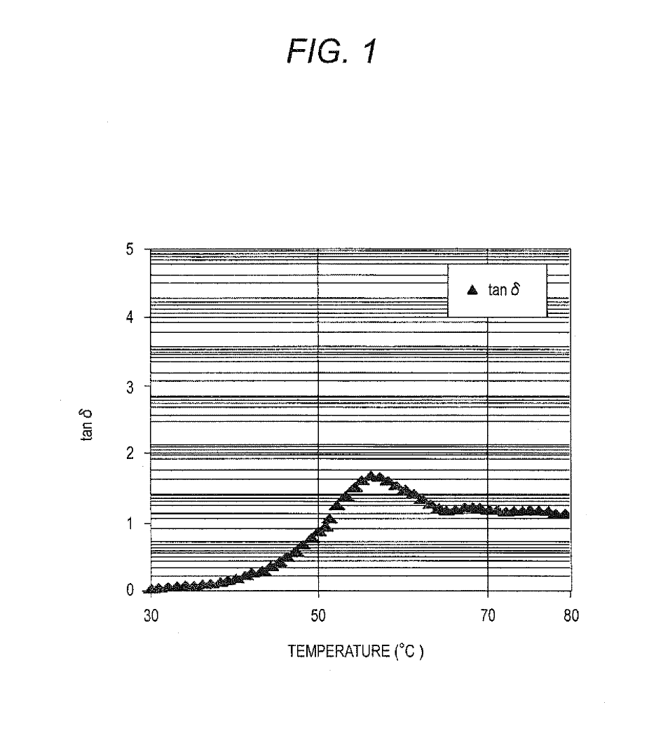

FIG. 1 is a view illustrating an example of the measurement results of tan δ of the toner. The temperature exhibiting the maximum value of tan 6 in the figure is approximately 55° C. In FIG. 1, the average gradient of the tan 8 value relative to the temperature in the range between a temperature lower by 10° C. and a temperature lower by 4° C., than the temperature (approximately 55° C.) exhibiting the maximum value of tan δ, is 0.13° C.⁻¹.

The method for calculating the average gradient of the tan δ value relative to the temperature in the range between a temperature lower by 10° C. and a temperature lower by 4° C., than the temperature exhibiting the maximum value of tan δ, from the measurement results of tan δ is as follows.

With respect to the temperature [° C.] and tan δ measured, a least square method is applied to the data set in the range between a temperature lower by 10° C. to a temperature lower by 4° C., than the temperature exhibiting the maximum value of tan δ, whereby the gradient of the approximation straight line of tan δ relative to the temperature can be obtained. This gradient is taken as the average gradient.

In the second exemplary embodiment of the present invention, as the method for adjusting tan δ of the toner, the gradient of tan δ relative to the temperature is adjusted to 0.10° C.⁻¹ or more, for example, by using a crystalline polyester resin in which the percentage of the fumaric acid-derived structural unit in the total amount of structural units derived from carboxylic acid components having a melting point of 70° C. or more is 30 mol % or more. Also, the temperature exhibiting the maximum value of tan δ is adjusted by regulating the glass transition temperature of the amorphous unsaturated polyester resin or amorphous saturated polyester resin or by controlling the compatibility of those amorphous polyester resins with the crystalline polyester resin.

### (External Additive)

The external additive includes, for example, an inorganic particle. The inorganic particle includes SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, MgSO₄, and the like.

The surface of the inorganic particle as an external additive is preferably subjected to a hydrophobization treatment. The hydrophobization treatment is performed, for example, by immersing the inorganic particle in a hydrophobization treating agent. The hydrophobization treating agent is not particularly limited but includes, for example, a silane-based coupling agent, a silicone oil, a titanate-based coupling agent, and an aluminum-based coupling agent. One of these compounds may be used alone, or two or more thereof may be used in combination.

The amount of the hydrophobization treating agent is usually, for example, from 1 part by mass to 10 parts by mass per 100 parts by mass of the inorganic particle.

The external additive also includes a resin particle (a resin particle of polystyrene, PMMA (polymethyl methacrylate), melamine resins and the like), a cleaning activator (for example, a metal salt of a higher fatty acid typified by zinc stearate, and a particle of a fluorine-based polymer having a high molecular weight), and the like.

The externally added amount of the external additive is, for example, preferably from 0.01 mass % to 5 mass %, more preferably from 0.01 mass % to 2.0 mass %, based on the toner particle.

The toner particle may be prepared by either a dry production method (for example, a kneading-pulverization method) or a wet production method (for example, an aggregation/coalescence method, a suspension polymerization method, and a dissolution-suspension method). The production method of the toner particle is not particularly limited to these production methods, and a known production method is employed.

Among others, the toner particle is preferably obtained by an aggregation/coalescence method.

Specifically, for example, in the case of producing the toner particle by an aggregation/coalescence method, the toner particle is produced through a step of preparing a resin particle dispersion liquid having dispersed therein a resin particle working out to a binder resin (a resin particle dispersion liquid preparing step), a step of aggregating the resin particles (if desired, other particles) in the resin particle dispersion liquid (in a dispersion liquid after other particle dispersion liquids are mixed, if desired) to form an aggregated particle (an aggregated particle forming step), and a step of heating the aggregated particle dispersion liquid having dispersed therein the aggregated particle and thereby fusing/coalescing aggregated particles to form a toner particle (a fusion/coalescing step).

In the production of the toner particle, a crosslinking step of crosslinking an amorphous unsaturated polyester resin present in the surface layer part of the toner particle, or an adhesion step of attaching a resin particle containing a crosslinking product of an amorphous unsaturated polyester resin to the surface of the toner particle, may be performed so that the surface layer of the toner particle can contain a crosslinking product of an amorphous unsaturated polyester resin.

In the crosslinking step, for example, after the fusion/coalescing step, a polymerization initiator may be added to a toner particle dispersion liquid containing the toner particle before crosslinking, to polymerize an amorphous unsaturated polyester resin present in the surface of the toner particle and thereby form a crosslinking product of an amorphous unsaturated polyester resin in the surface of the toner particle.

On the other hand, in the adhesion step, for example, a step of forming the later-described second aggregated particle by using a resin particle dispersion liquid containing a crosslinked particle resulting from crosslinking of an amorphous unsaturated polyester resin may be performed to thereby attach a resin particle containing a crosslinking product of an amorphous unsaturated polyester resin to the surface of the toner particle.

The surface layer of the toner according to an exemplary embodiment of the present invention may be configured to contain a crosslinking product of an amorphous unsaturated polyester resin by performing the above-described crosslinking step or adhesion step,

Incidentally, in the case of producing the toner particle by a kneading-pulverization method, a crosslinking product of an amorphous unsaturated polyester resin may be formed in the surface of the toner particle by dispersing the toner particle produced by a kneading-pulverization method in an aqueous medium, adding a polymerization initiator to the medium, and polymerizing an amorphous unsaturated polyester resin present in the surface of the toner particle.

Each step is described in detail below.

In the following, a method for obtaining a toner particle containing a coloring agent and a release agent is described, but a coloring agent and a release agent are additives used, if desired. Of course, additives other than a coloring agent and release agent may also be used.

### —Resin Particle Dispersion Liquid Preparing Step—

First, as well as a resin particle dispersion liquid having dispersed therein a resin particle working out to a binder resin, for example, a coloring agent particle dispersion liquid having dispersed therein a coloring agent particle, and a release agent dispersion liquid having dispersed therein a release agent particle are prepared.

Here, the resin particle dispersion liquid is prepared, for example, by dispersing a resin particle in a dispersion medium with the aid of a surfactant.

The dispersion medium for use in the resin particle dispersion liquid includes, for example, an aqueous medium.

The aqueous medium includes, for example, water such as distilled water and ion-exchanged water, and alcohols. One of these may be used alone, or two or more thereof may be used in combination.

The surfactant includes, for example, an anionic surfactant such as sulfate salt type, sulfonate salt type, phosphoric acid ester type and soap type; a cationic surfactant such as amine salt type and quaternary ammonium salt type; and a nonionic surfactant such as polyethylene glycol type, alkylphenol ethylene oxide adduct type and polyhydric alcohol type. Among these, an anionic surfactant and a cationic surfactant are preferred. The nonionic surfactant may be used in combination with an anionic surfactant or a cationic surfactant.

One surfactant may be used alone, or two or more surfactants may be used in combination.

In the resin particle dispersion liquid, the method for dispersing the resin particle in a dispersion medium includes, for example, a rotation shearing homogenizer and a general dispersing method using media, such as ball mill, sand mill and dynomill. Also, depending on the kind of the resin particle, the resin particle may be dispersed in the resin particle dispersion liquid by using, for example, a phase inversion emulsification method.

Incidentally, the phase inversion emulsification method is a method of dissolving a resin to be dispersed, in a hydrophobic organic solvent in which the resin is soluble, adding a base to a continuous organic phase (O phase) to cause neutralization, and then charging an aqueous medium (W phase) to invert the resin from W/O to O/W (so-called phase inversion) and make a discontinuous phase, thereby dispersing the resin as particles in the aqueous medium.

The volume average particle diameter of the resin particle dispersed in the resin particle dispersion liquid is, for example, preferably from 0.01 μm to 1 μm, more preferably from 0.08 μm to 0.8 μm, still more preferably from 0.1 μm to 0.6 μm.

The volume average particle diameter of the resin particle is determined by drawing a cumulative volume distribution from the small diameter side for divided particle size ranges (channels) based on a particle size distribution obtained by measurement with a laser diffraction particle size distribution meter (for example, LA-700, manufactured by Horiba, Ltd.) and taking the particle size at an accumulation of 50% relative to all particles as the volume average particle diameter D50v. Incidentally, the volume average particle diameter of particles in other dispersion liquids is measured in the same manner.

The content of the resin particle contained in the resin particle dispersion liquid is, for example, preferably from 5 mass % to 50 mass %, more preferably from 10 mass % to 40 mass %.

Similarly to the resin particle dispersion, for example, a coloring agent dispersion liquid and a release agent dispersion liquid are also prepared. That is, with respect to the volume average particle diameter of particles, the dispersion medium, the dispersion method and the content of the particle in the resin particle dispersion, the same applies to the coloring agent particle dispersed in the coloring agent dispersion liquid and the release agent particle dispersed in the release agent dispersion liquid.

### —Aggregated Particle Forming Step—

Next, a coloring agent particle dispersion liquid and a release agent dispersion liquid are mixed together with the resin particle dispersion liquid.

In the mixed dispersion liquid, a resin particle, a coloring agent particle and a release agent particle are hetero-aggregated to form an aggregated particle having a diameter close to the diameter of a toner particle and containing a resin particle, a coloring agent particle and a release agent particle.

Specifically, for example, as well as adding a coagulant to the mixed dispersion liquid, the mixed dispersion liquid is adjusted to acidic pH (for example, a pH of 2 to 5) and after adding, if desired, a dispersion stabilizer, heated at a temperature of glass transition temperature of the resin particle (specifically, for example, from glass transition temperature of resin particle—30° C. to glass transition temperature—10° C.) to aggregate particles dispersed in the mixed dispersion liquid and form an aggregated particle.

In the aggregated particle forming step, for example, the coagulant above may be added at room temperature (for example, 25° C.) while stirring the mixed dispersion liquid by a rotation shearing homogenizer and after adjusting the mixed dispersion liquid to acidic pH (for example, a pH of 2 to 5) and adding, if desired, a dispersion stabilizer, the above-described heating may be performed.

The coagulant includes, for example, a surfactant having polarity reverse to that of the surfactant used as a dispersant added to the mixed dispersion liquid, such as inorganic metal salt and divalent or higher valent metal complex. In particular, when a metal complex is used as the coagulant, the amount of the surfactant used is decreased, and the charging properties are enhanced.

An additive forming a complex or similar bond with a metal ion of the coagulant may be used, if desired. As this additive, a chelating agent is preferably used.

The inorganic metal salt includes, for example, a metal salt such as calcium chloride, calcium nitrate, barium chloride, magnesium chloride, zinc chloride, aluminum chloride and aluminum sulfate, and an inorganic metal salt polymer such as polyaluminum chloride, polyaluminum hydroxide and calcium polysulfide.

As the chelating agent, a water-soluble chelating agent may also be used. The chelating agent includes, for example, an oxycarboxylic acid such as tartaric acid, citric acid and gluconic acid, an iminodiacetic acid (IDA), a nitrilotriacetic acid (NTA), and an ethylenediaminetetraacetic acid (EDTA).

The amount of the chelating agent added is preferably from 0.01 parts by mass to 5.0 parts by mass, more preferably from 0.1 parts by mass to less than 3.0 parts by mass, per 100 parts by mass of the resin particle.

### —Fusion/Coalescing Step—

Next, the aggregated particle dispersion liquid having dispersed therein an aggregated particle is heated, for example, at not less than the glass transition temperature of the resin particle (for example, not less than a temperature higher by 10° C. to 30° C. than the glass transition temperature of the resin particle) to fuse/coalesce the aggregated particles and form a toner particle.

The toner particle is obtained through these steps.

Incidentally, the toner particle may also be produced through, after the aggregated particle dispersion liquid having dispersed therein an aggregated particle is obtained, a step of further mixing and aggregating the aggregated particle dispersion liquid and the resin particle dispersion liquid having dispersed therein a resin particle to further attach a resin particle to the surface of the aggregated particle and thereby form a second aggregated particle, and a step of heating the second aggregated particle dispersion liquid having dispersed therein a second aggregated particle to fuse/coalesce second aggregated particles and form a toner particle having a core/shell structure.

After the completion of fusion/coalescing step, the above-described crosslinking step is performed, if desired, and the toner particle formed in a solution is subjected to known washing step, solid-liquid separation step and drying step to obtain a dry toner particle.

In the washing step, full displacement washing with ion exchanged water is preferably performed in view of chargeability. Also, the solid-liquid separation step is not particularly limited, but in view of productivity, suction filtration, pressure filtration, or the like is preferably performed. In addition, the drying step is also not particularly limited in its method, but in view of productivity, freeze drying, flash jet drying, fluidized drying, vibration-type fluidized drying, or the like is preferably performed.

The polymerization initiator used in the crosslinking step is not particularly limited.

The polymerization initiator for use in the second exemplary embodiment of the present invention includes, for example, as a water-soluble polymerization initiator, peroxides such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, tert-butyl hydroperoxide pertriphenylacetate, tert-butyl performate, tert-butyl peracetate, tert-butyl perbenzoate, tert-butyl perphenylacetate, tert-butyl permethoxyacetate, tert-butyl per-N-(3-toluoyl)carbamate, ammonium bisulfate and sodium bisulfate, but the present invention is not limited thereto.

Also, the oil-soluble polymerization initiator includes, for example, an azo-based polymerization initiator such as 2,2′-azobisisobutyronitrile, 2,2′-azobis(2,4-dimethylvaleronitrile), 1,1′-azobis(cyclohexane-1-carbonitrile), and 2,2′-azobis-4-methoxy-2,4-dimethylvaleronitrile.

The toner according to the second exemplary embodiment of the present invention is produced, for example, by adding an external additive to the obtained dry toner particle and mixing them. The mixing is preferably performed, for example, by a V-blender, a Henschel mixer, or a Lodige mixer. Furthermore, if desired, coarse toner particles may be removed using a vibration sieving machine, a wind power sieving machine, or the like.

The method for producing the toner particle by a dissolution suspension method is described in detail below.

The dissolution suspension method is a method where a liquid prepared by dissolving or dispersing a material containing a binder resin and other components used, if desired, such as coloring agent and release agent, in a solvent in which the binder resin is soluble is granulated in a water medium containing an inorganic dispersant and thereafter, the solvent is removed to obtain a toner particle.

Other components used in the dissolution suspension method include, in addition to a coloring agent and a release agent, various components such as internal additive, charge controlling agent, inorganic powder (inorganic particle) and organic particle.

In the second exemplary embodiment of the present invention, the binder resin and other components used, if desired, are dissolved or dispersed in a solvent in which the binder resin is soluble. Whether the binder resin is soluble or not relies on the constituent component of binder resin, the molecular chain length, the three-dimensional degree and the like, and the solvent cannot be indiscriminately specified, but, for example, a hydrocarbon such as toluene, xylene and hexane, a halogenated hydrocarbon such as methylene chloride, chloroform, dichloroethane and dichloroethylene, an alcohol or ether such as ethanol, butanol, benzylalcohol ethyl ether, benzylalcohol isopropyl ether, tetrahydrofuran and tetrahydropyran, an ester such as methyl acetate, ethyl acetate, butyl acetate and isopropyl acetate, and a ketone or acetal such as acetone, methyl ethyl ketone, isobutyl ketone, dimethyl oxide, diacetone alcohol, cyclohexanone and methylcyclohexanone, are used in general.

Such a solvent dissolves the binder resin and need not dissolve other components such as coloring agent and release agent. Other components such as coloring agent and release agent may be sufficient if they can be dispersed in the binder resin solution. The amount of the solvent used is not limited and may be an amount sufficient to give a viscosity enabling granulation in a water medium. The ratio between the material (former) containing a binder resin and other components such as coloring agent and release agent and the solvent (latter) is preferably from 10/90 to 50/50 (mass ratio of former/latter) in view of ease of granulation and yield of the final toner particle.

The liquid (toner mother liquid) obtained by dissolving or dispersing the binder resin and other components such as coloring agent and release agent in a solvent is granulated in a water medium containing an inorganic dispersant to have a previously determined particle diameter. As the water medium, water is mainly used. The mixing ratio between the water medium and the toner mother liquid is preferably water medium/mother liquid=from 90/10 to 50/50 (mass ratio). The inorganic dispersant is preferably a dispersant selected from tricalcium phosphate, hydroxyapatite, calcium carbonate, titanium oxide and silica powder. The amount of the inorganic dispersant is determined according to the particle diameter of the particle granulated, but in general, the inorganic dispersant is preferably used in a range of 0.1 mass % to 15 mass % based on the toner mother liquid. When the amount used is 0.1 mass % or more, granulation successfully proceeds, and when the amount used is 15 mass % or less, generation of an unnecessary fine particle is suppressed, making it possible to obtain the target particle in a high yield.

In order to successfully granulate the toner mother liquid in a water medium containing an inorganic dispersant, an adjuvant may be added to the water medium. The adjuvant includes known cationic, anionic and nonionic surfactants, and an anionic surfactant is preferred. Examples thereof include sodium alkylbenzenesulfonate, sodium α-olefin sulfonate, and sodium alkylsulfonate. Such an adjuvant is preferably used in a range of 1×10⁻⁴ mass % to 0.1 mass % based on the toner mother liquid.

The granulation of toner mother liquid in a water medium containing an inorganic dispersant is preferably performed under shearing conditions. The toner mother liquid dispersed in the water medium is preferably granulated to an average particle diameter of 9 μm or less, more preferably from 3.5 μm to 7 μm.

The apparatus equipped with a shearing mechanism includes various dispersing machines, and among others, a homogenizer is preferred. By using a homogenizer, substances incompatible with each other (in an exemplary embodiment of the present invention, the inorganic dispersant-containing water medium and the toner mother liquid) are passed through a gap between a casing and a rotating rotor, so that a substances incompatible with a certain liquid can be dispersed as particles in the liquid. The homogenizer includes TK Homomixer, Line-Flow Homomixer, Autohomomixer (all manufactured by Tokushu Kika Kogyo Co., Ltd.), Silverson Homogenizer (manufactured by Silverson Ltd.), Polytron Homogenizer (manufactured by KINEMATICA AG), and the like.

The stirring condition when using a homogenizer is preferably 2 m/sec or more in terms of the circumferential velocity of the rotor blade. With a circumferential velocity in the range above, particle formation is facilitated. In an exemplary embodiment of the present invention, after the toner mother liquid is granulated in a water medium containing an inorganic dispersant, the solvent is removed. The removal of solvent may be performed at ordinary temperature (25° C.) under atmospheric pressure, but this removal takes a long time, and therefore, the removal of solvent is preferably performed under the temperature condition where the temperature is lower than the boiling point of the solvent and the difference from the boiling point is 80° C. or less. The pressure may be either atmospheric pressure or reduced pressure, but in the case of removing the solvent under reduced pressure, the removal is preferably performed at 20 mmHg to 150 mmHg.

The toner particle obtained by the above-described dissolution suspension method is preferably washed with hydrochloric acid or the like after the removal of solvent. By this washing, the inorganic dispersant remaining on the toner particle surface can be removed, as a result, the toner particle can restore its original composition and be enhanced in the properties. Subsequently, a crosslinking step of crosslinking the amorphous unsaturated polyester resin present in the surface layer part of the toner particle is performed so as to allow the surface layer part of the toner particle to contain a crosslinking product of the amorphous unsaturated polyester resin, and thereafter, the particle is dehydrated and dried, whereby a toner particle in the powder form can be obtained.

Similarly to the aggregation/coalescence method, the toner particle obtained by the dissolution suspension method may be added/attached with an external additive such as inorganic oxide typified by silica, titania and aluminum oxide, for the purpose of, for example, adjusting the electrostatic charge, imparting fluidity, or imparting charge exchangeability. In addition to the above-described inorganic oxide and the like, other components (particles) such as charge controlling agent, organic particle material, lubricant and abrasive may be added as an external additive.

### <Electrostatic Image Developer>

The electrostatic image developer according to an exemplary embodiment of the present invention contains at least the tanner according to the first exemplary embodiment or the second exemplary embodiment of the present invention.

The electrostatic image developer according to an exemplary embodiment of the present invention may be a single-component developer containing only the toner according to the first exemplary embodiment or the second exemplary embodiment of the present invention or may be a two-component developer obtained by mixing the toner with a carrier.

The carrier is not particularly limited and includes a known carrier. The carrier includes, for example, a coated carrier obtained by coating the surface of a core material composed of a magnetic material with a coating resin; a magnetic powder dispersion-type carrier obtained by dispersing/blending a magnetic powder in a matrix resin; a resin-impregnated carrier obtained by impregnating a porous magnetic powder with a resin; and a resin dispersion-type carrier obtained by dispersing/blending an electrically conductive material in a matrix resin.

Incidentally, the magnetic powder dispersion-type carrier, resin-impregnated carrier and electrically conductive particle dispersion-type carrier may be a carrier where a constituent particle of the carrier is used as the core material and coated with a coating resin.

The magnetic powder includes, for example, a magnetic metal such as iron oxide, nickel and cobalt, and a magnetic oxide such as ferrite and magnetite.

The electrically conductive particle includes particles of a metal such as gold, silver and copper, carbon black, titanium oxide, zinc oxide, tin oxide, barium sulfate, aluminum borate, potassium titanate, and the like.

The coating resin and matrix resin include, for example, polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, an organosiloxane bond-containing straight silicone resin or a modified product thereof, fluororesin, polyester, polycarbonate, phenolic resin, and epoxy resin.

Incidentally, in the coating resin and matrix resin, other additives such as electrically conductive material may be incorporated.

The method for coating the surface of a core material with a coating resin includes, for example, coating with a coating layer-forming solution obtained by dissolving the coating resin and, if desired, various additives in an appropriate solvent. The solvent is not particularly limited and may be selected taking into account the coating resin used, suitability for coating, and the like.

Specific examples of the resin coating method include a dipping method of dipping the core material in the coating layer-forming solution, a spray method of spraying the coating layer-forming solution onto the core material surface, a fluidized bed method of spraying the coating layer-forming solution in the state of the core material being floated by fluidizing air, and a kneader-coater method of mixing the core material of the carrier with the coating layer-forming solution in a kneader-coater and removing the solvent.

The mixing ratio (mass ratio) between the toner and the carrier in the two-component developer is preferably toner: carrier=from 1:100 to 30:100, more preferably from 3:100 to 20:100.

### <Image Forming Apparatus/Image Forming Method>

The image forming apparatus/image forming method according to an exemplary embodiment of the present invention are described.

The image forming apparatus according to an exemplary embodiment of the present invention includes an image holding member, a charging unit for charging the surface of the image holding member, an electrostatic image forming unit for forming an electrostatic image on the charged surface of the image holding member, a developing unit for housing an electrostatic image developer and developing the electrostatic image formed on the surface of the image holding member to form a toner image, a transfer unit for transferring the toner image formed on the surface of the image holding member onto a recording medium, and a fixing unit for fixing the toner image transferred onto the surface of the recording medium. As the electrostatic image developer, the electrostatic image developer according to an exemplary embodiment of the present invention is applied.

In the image forming apparatus according to an exemplary embodiment of the present invention, an image forming method including a charging step of charging the surface of an image holding member, an electrostatic image forming step of forming an electrostatic image on the charged surface of the image holding member, a developing step of developing the electrostatic image formed on the surface of the image holding member with the electrostatic image developer according to an exemplary embodiment of the present invention to form a toner image, a transfer step of transferring the toner image formed on the surface of the image holding member onto the surface of a recording medium, and a fixing step of fixing the toner image transferred onto the surface of the recording medium (the image forming method according to an exemplary embodiment of the present invention), is performed.

As for the image forming apparatus according to an exemplary embodiment of the present invention, there is applied a known image forming apparatus such as a direct transfer-type apparatus where a toner image formed on the surface of an image holding member is transferred directly onto a recording medium; an intermediate transfer-type apparatus where a toner image foamed on the surface of an image holding member is primarily transferred onto the surface of an intermediate transfer material and the toner image transferred onto the surface of the intermediate transfer material is secondarily transferred onto the surface of a recording medium; an apparatus equipped with a cleaning unit for cleaning the surface of an image holding member after transfer of a toner image but before charging; and an apparatus equipped with a destaticizing unit for irradiating the surface of an image holding member after transfer of a toner image but before charging, with destaticizing light to remove electrostatic charge.

In the case of an intermediate transfer-type apparatus, the configuration applied to the transfer unit consists of for example, an intermediate transfer material onto the surface of which a toner image is transferred, a primary transfer unit for primarily transferring a toner image formed on the surface of an image holding member onto the surface of the intermediate transfer material, and a secondary transfer unit for secondarily transferring the toner image transferred onto the surface of the intermediate transfer material, onto the surface of a recording medium.

Incidentally, in the image forming apparatus according to an exemplary embodiment of the present invention, for example, the portion containing the developing unit may be a cartridge structure (process cartridge) capable of being detachably mounted in the image forming apparatus. As the process cartridge, for example, a process cartridge housing the electrostatic image developer according to an exemplary embodiment of the present invention and having a developing unit is suitably used.

One example of the image Beaming apparatus according to an exemplary embodiment of the present invention is described below, but the present invention is not limited thereto. Incidentally, main parts shown in the figure are illustrated, and description of others is omitted.

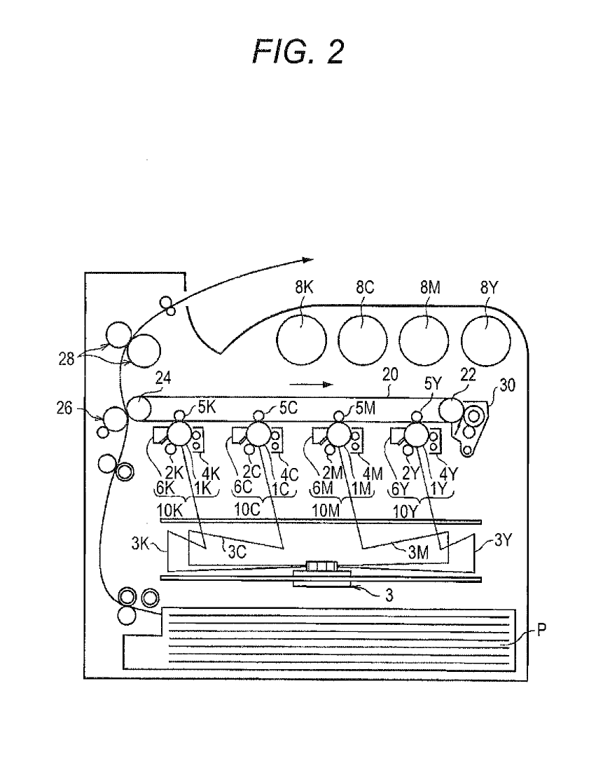

FIG. 2 is a schematic configuration diagram showing an image forming apparatus according to an exemplary embodiment of the present invention.

The image forming apparatus shown in FIG. 2 is equipped with first to fourth electrophotographic image forming units 10Y, 10M, 10C and 10K (image forming unit) for outputting an image of each color of yellow (Y), magenta (M), cyan (C) and black (K) based on the color-separated image data. These image forming units (hereinafter, sometimes simply referred to as “units”) 10Y, 10M, 10C and 10K are arranged in parallel with a predetermined spacing in the horizontal direction. Incidentally, each of these units 10Y, 10M, 10C and 10K may be a process cartridge capable of being detachably mounted in the image forming apparatus.

Above respective units 10Y, 10M, 10C and 10K in the figure, an intermediate transfer belt 20 is disposed extending as an intermediate transfer material over respective units. The intermediate transfer belt 20 is provided by winding it around a driving roller 22 and a supporting roller 24 put into contact with the inner surface of the intermediate transfer belt 20, these rollers being arranged to be apart from each other in the left-to-right direction in the figure, and is configured to run in the direction toward fourth unit 10K from first unit 10Y, Incidentally, the supporting roller 24 is biased in the direction away from the driving roller 22 by a spring or the like (not shown), and a tension is given to the intermediate transfer belt 20 wound around those two rollers. An intermediate transfer member cleaning unit 30 is provided on the image holding member-side surface of the intermediate transfer belt 20 to face the driving roller 22.

Toners including toners of four colors of yellow, magenta, cyan and black, which are housed in toner cartridges 8Y, 8M, 8C and 8K, are supplied respectively to developing units 4Y, 4M, 4C and 4K of the units 10Y, 10M, 10C and 10K.

First to fourth units 10Y, 10M, 10C and 10K have the same configuration and therefore, first unit 10Y for forming a yellow image, which is arranged on the upstream side in the running direction of the intermediate transfer belt, is described here as a representative of those units. Incidentally, description of second to fourth units 10M, 10C and 10K is omitted by assigning reference numerals of magenta (M), cyan (C) and black (K) in place of yellow (Y) to the equivalent parts of first unit 10Y.

First unit 10Y has a photoreceptor 1Y acting as an image holding member. A charging roller (one example of the charging unit) 2Y for charging the surface of the photoreceptor 1Y to a predetermined potential, an exposure unit (one example of the electrostatic image forming unit) 3 for exposing the charged surface to a laser beam 3Y based on color-separated image signals to form an electrostatic image, a developing device (one example of the developing unit) 4Y for developing the electrostatic image by supplying an charged toner to the electrostatic image, a primary transfer roller (one example of the primary transfer unit) 5Y for transferring the developed toner image onto the intermediate transfer belt 20, and a photoreceptor cleaning device (one example of the cleaning unit) 6Y for removing the toner remaining on the surface of the photoreceptor 1Y after the primary transfer are sequentially disposed on the periphery of the photoreceptor 1Y.

Incidentally, the primary transfer roller 5Y is arranged on the inner side of the intermediate transfer belt 20 and is provided at a position facing the photoreceptor 1Y. Furthermore, a bias power source (not shown) for applying a primary transfer bias is connected to each of the primary transfer rollers 5Y, 5M, 5C and 5K. Each bias power source can change the transfer bias applied to each primary transfer roller through control by a controller (not shown).

The operation of forming a yellow image in first unit 10Y is described below.

First, the surface of the photoreceptor 1Y is charged at a potential of −600 V to −800 V with a charging roller 2Y in advance of operation.

The photoreceptor 1Y is formed by stacking a photosensitive layer on an electrically conductive (for example, volume resistivity at 20° C.: 1×10⁻⁶ Ωcm or less) substrate. This photosensitive layer has a property such that the resistance is usually high (resistance of a general resin) but upon irradiation with a laser beam 3Y, the specific resistance of the portion irradiated with the laser beam varies. Therefore, a laser beam 3Y is output through the exposure device 3 onto the charged surface of the photoreceptor 1Y according to yellow image data transmitted from a controller (not shown). The photosensitive layer on the surface of the photoreceptor 1Y is irradiated with the laser beam 3Y, whereby an electrostatic image of a yellow image pattern is formed on the surface of the photoreceptor 1Y.

The electrostatic image is an image formed on the surface of the photoreceptor 1Y by charging and is a so-called negative image formed resulting from flow of the charge electrified on the surface of the photoreceptor 1Y due to decrease in the specific resistance in the portion of the photosensitive layer irradiated with the laser beam 3Y and, on the other hand, remaining of the charge in the portion not irradiated with the laser beam 3Y.

The electrostatic image formed on the photoreceptor 1Y is rotated to a predetermined development position along with running of the photoreceptor 1Y. At this development position, the electrostatic image on the photoreceptor 1Y is visualized (developed) as a toner image with the developing device 4Y.

In the developing device 4Y, for example, an electrostatic image developer containing at least a yellow toner and a carrier is housed. The yellow toner is frictionally electrified due to stirring inside the developing device 4Y and is held on a developer roll (one example of the developer holding member) by having a charge with the same polarity (negative polarity) as that of the charge electrified on the photoreceptor 1Y. In the course of the photoreceptor 1Y surface passing through the developing device 4Y, the yellow toner electrostatically adheres to the destaticized latent image part on the photoreceptor 1Y surface, and the latent image is developed with the yellow toner. The photoreceptor 1Y having formed thereon a yellow toner image is caused to continuously run at a predetermined speed, and the toner image developed on the photoreceptor 1Y is conveyed to a predetermined primary transfer position,

When the yellow toner image on the photoreceptor 1Y is conveyed to primary transfer, a primary transfer bias is applied to the primary transfer roller 5Y, and an electrostatic force directed from the photoreceptor 1Y to the primary transfer roller 5Y acts on the toner image, as a result, the toner image on the photoreceptor 1Y is transferred onto the intermediate transfer belt 20. The transfer bias applied here has (+) polarity opposite the polarity (−) of the toner and, for example, in first unit 10Y, the transfer bias is controlled to +10 μA by a controller (not shown).

On the other hand, the toner remaining on the photoreceptor 1Y is removed and collected by the photoreceptor cleaning device 6Y.

The primary transfer biases applied to the primary transfer rollers 5M, 5C and 5K of second unit 10M and the subsequent units are also controlled in accordance with the first unit.

In this way, the intermediate transfer belt 20 having the yellow toner image transferred in the first unit 10Y is sequentially conveyed over second to fourth units 10M, 10C and 10K, and toner images of respective colors are superposed and multi-transferred.

The intermediate transfer belt 20, onto which the toner images of four colors are multi-transferred by first to fourth units, reaches a secondary transfer part composed of the intermediate transfer belt 20, the supporting roller 24 in contact with the inner surface of the intermediate transfer belt, and a secondary transfer roller (one example of the secondary transfer unit) 26 disposed on the image holding surface side of the intermediate transfer belt 20. On the other hand, a recording paper sheet (one example of the recording medium) P is fed by a feed mechanism at a predetermined timing to a gap where the secondary transfer roller 26 comes into contact with the intermediate transfer belt 20, and a secondary transfer bias is applied to the supporting roller 24. The transfer bias applied here has the same (−) polarity as the polarity (−) of the toner, and an electrostatic force directed from the intermediate transfer belt 20 to the recording paper sheet P acts on the toner image, as a result, the toner image on the intermediate transfer belt 20 is transferred onto the recording paper sheet P. Incidentally, this secondary transfer bias is determined according to the resistance detected by a resistance detecting unit (not shown) for detecting the resistance of the secondary transfer part and is voltage-controlled.

Thereafter, the recording paper sheet P is delivered to a pressure-contact part (nip part) of a pair of fixing rollers in the fixing device (one example of the fixing unit) 28, and the toner images are fixed on the recording paper sheet P, whereby a fixed image is formed.

The recording paper sheet P onto which the toner images are transferred includes, for example, plain paper used for an electrophotographic copying machine, printer, or the like. In addition to the recording paper sheet P, the recording medium includes OHP sheet, and the like.

In order to further improve the smoothness of the surface of the image after fixing, the surface of the recording paper sheet P is also preferably smooth and, for example, coated paper obtained by coating the surface of plain paper with a resin or the like, art paper for printing, and the like are appropriately used.

The recording paper sheet P after completing the fixing of a color image is conveyed to the ejection part, whereby a series of color image forming operations are terminated.

### <Process Cartridge/Toner Cartridge>

The process cartridge according to an exemplary embodiment of the present invention is described.

The process cartridge according to an exemplary embodiment of the present invention is a process cartridge capable of mounting on or demounting on the image forming apparatus and equipped with a developing unit for housing the electrostatic image developer according to an exemplary embodiment of the present invention and developing the electrostatic image formed on the surface of the image holding member with the electrostatic image developer to form a toner image.

Incidentally, the process cartridge according to an exemplary embodiment of the present invention is not limited to the above-described configuration and may be configured to have a developing device and, if desired, other units, for example, at least one member selected from other units such as image holding member, charging unit, electrostatic image forming unit and transfer unit.

One example of the process cartridge according to an exemplary embodiment of the present invention is described below, but the present invention is not limited thereto. Incidentally, main parts shown in the figure are illustrated, and description of others is omitted.

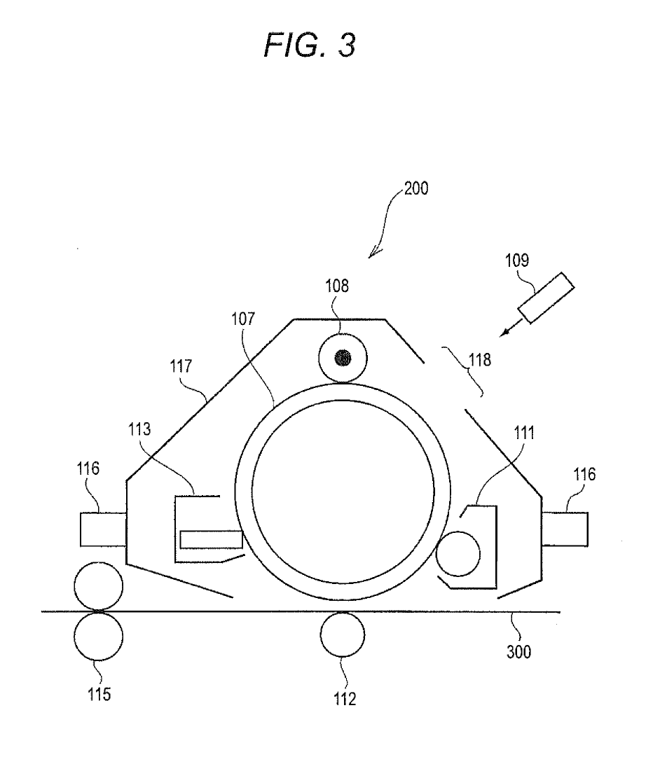

FIG. 3 is a schematic configuration diagram illustrating the process cartridge according to an exemplary embodiment of the present embodiment.

The process cartridge 200 shown in FIG. 3 has a configuration where, for example, a photoreceptor 107 (one example of the image holding member), an charging roller 108 (one example of the charging unit) disposed on the periphery of the photoreceptor 107, a developing device 111 (one example of the developing unit), and a photoreceptor cleaning device 113 (one example of the cleaning unit) are held in an integrally combined manner by a mounting rail 116 and a casing 117 having an opening 118 for exposure and formed into a cartridge.

Incidentally, in FIG. 3, 109 is an exposure device (one example of the electrostatic image forming unit), 112 is a transfer device (one example of the transfer unit), 115 is a fixing device (one example of the fixing unit), and 300 is a recording paper sheet (one example of the recording medium).

The toner cartridge according to an exemplary embodiment of the present invention is described below.

The toner cartridge according to an exemplary embodiment of the present invention is a toner cartridge housing the toner according to an exemplary embodiment of the present invention and being detachably mounted in an image forming apparatus. The toner cartridge houses a supplementary tonner that is supplied to the developing unit provided in the image forming apparatus

The image forming apparatus shown in FIG. 2 is an image forming apparatus having detachably mounted toner cartridges 8Y, 8M, 8C and 8K, and developing devices 4Y, 4M, 4C and 4K are connected to toner cartridges corresponding to respective developing devices (colors) through toner supply tubes (not shown), In the case where the amount of the toner housed in the toner cartridge is reduced, this toner cartridge is replaced.

### EXAMPLES

The exemplary embodiments of the present invention are described in greater detail below by referring to Examples and Comparative Examples, but the exemplary embodiments of the present invention are not limited to the following Examples.

### (Each Measuring Method)

### <Measuring Method of Particle Diameter>

The measuring method of the particle diameter is described.

In the case where the particle diameter measured is 2 μm or more, Coulter Multisizer-II (manufactured by Coulter) is used as the measuring apparatus, and ISOTON-II (produced by Coulter) is used as the electrolytic solution.

In the case where the particle diameter measured is less than 2 μm, the measurement is performed using a laser diffraction particle size distribution meter (LA-700, manufactured by Horiba, Ltd.).

### <Measuring Method of Molecular Weight>

The molecular weight is measured under the following conditions. GPC is performed using an “HLC-8120GPC, SC-8020 (manufactured by Tosoh Corporation) apparatus”, two “TSKgel, SuperHM-H (6.0 mm IDx15 cm, manufactured by Tosoh Corporation)” as the column, and THF (tetrahydrofuran) as an eluent. The experiment is performed using an RI detector under the experimental conditions of a sample concentration of 0.5%, a flow velocity of 0.6 mL/min, a sample injection amount of 10 μL, and a measurement temperature of 40° C. Also, the calibration curve is prepared from 10 samples, “polystyrene standard sample TSK standard”: “A-500”, “F-1”, “F-10”, “F-80”, “F-380”, “A-2500”, “F-4”, “F-40”, “F-128” and “F-700”, produced by Tosoh Corporation.

### <Measuring Method of Glass Transition Temperature>

The glass transition temperature is measured by the DSC (differential scanning calorimeter) measuring method, and a primary maximum peak measured in accordance with ASTMD 3418-8 is determined and taken as the glass transition temperature.

In the measurement of the primary maximum peak, DSC-7 manufactured by Perkin-Elmer is used. For the temperature correction of the detective part of this apparatus, the melting temperatures of indium and zinc are used, and for the calorie correction, the melting heat of indium is used. The sample is measured at a temperature rise rate of 10° C./rain by using an aluminum-made pan and setting an empty pan for comparison.

### <Check Whether or not the Surface Layer Part Contains a Crosslinking Product>

Whether or not the surface layer part of the toner (toner particle) contains a crosslinking product is checked by the above-described method.

### (Synthesis of Amorphous Polyester Resin)

### —Polyester Resin Having Ethylenically Unsaturated Double Bond—

80 Parts by mol of bisphenol A propylene oxide 2-mol adduct, 20 parts by mol of bisphenol A ethylene oxide 2-mol adduct, 10 parts by mol of terephthalic acid, 30 parts by mol of dodecenylsuccinic acid, 50 parts by mol of fumaric acid, and 0.1 parts by mol of dibutyltin oxide are put into a heated and dried three-neck flask, and after decreasing the pressure in the vessel by a pressure reducing operation and furthermore creating an inert atmosphere with nitrogen gas, the mixture is reacted for 10 hours at 230° C. under normal pressure (101.3 kPa) with mechanical stirring and further reacted for 1 hour at 8 kPa. The reaction product is cooled to 210° C., and 10 parts by mol of trimellitic anhydride is added. This mixture is reacted for 1 hour and thereafter, reacted at 8 kPa until the softening temperature becomes 115° C., whereby an amorphous polyester resin is obtained. The glass transition temperature of the amorphous polyester resin is 60° C.

### (Preparation of Amorphous Polyester Resin Particle Dispersion Liquid)

500 Parts by mass of the amorphous polyester resin, 320 parts by mass of methyl ethyl ketone, 125 parts by mass of isopropyl alcohol, and 5.0 parts by mass of an aqueous 10 mass % ammonia solution are put into a separable flask, mixed and dissolved, and ion-exchanged water is then added dropwise by a liquid feeding pump with stirring under heating at 50° C. Subsequently, the solvent is removed under reduced pressure, and after adding 50 parts by mass of an aqueous 20 mass % sodium dodecylbenzenesulfonate solution to the amorphous polyester resin particle dispersion liquid from which the solvent is removed, ion-exchanged water is added to adjust the solid content concentration to 40 mass %, whereby an amorphous polyester resin particle dispersion liquid is obtained. The volume average particle diameter of the obtained polyester resin particle is 190 nm.

### (Synthesis of Crystalline Polyester Resin)

44 Parts by mol of 1,9-nonanediol, 56 parts by mol of dodecanedicarboxylic acid, and 0.05 parts by mol of dibutyltin oxide are put into a heated and dried three-neck flask, and after raising the temperature while keeping an inert atmosphere by introducing nitrogen gas into the vessel, a condensation polymerization reaction is performed for 2 hours at 150° C. to 230° C. Thereafter, the temperature is gradually raised to 230° C., and the system is stirred for 5 hours and on reaching a viscous state, air-cooled to stop the reaction, whereby a crystalline polyester resin is synthesized.

### (Preparation of Crystalline Polyester Resin Particle Dispersion Liquid)

3,000 Parts by mass of the obtained crystalline polyester resin, 10,000 parts by mass of ion-exchanged water, and 60 parts by mass of sodium dodecylbenzenesulfonate are put into an emulsifying tank of a high-temperature and high-pressure emulsifying apparatus (CAVITRON CD1010), and the mixture is heated and melted at 130° C., then dispersed at 110° C., a flow rate of 3 μm and 10,000 rpm for 30 minutes and furthermore, passed through a cooling tank to produce a crystalline polyester resin particle dispersion liquid having a solid content of 40 mass % and a volume average particle diameter D50v of 125 nm.

### (Preparation of Incompatible Resin Particle Dispersion Liquid 1)

480 Parts by mass of styrene, 120 parts by mass of methyl methacrylate, and 6 parts by mass of carboxyethyl acrylate are added to a dispersion medium obtained by dissolving 6 parts by mass of a surfactant (sodium diphenyl oxide disulfonate) in 250 parts by mass of ion-exchanged water, and dispersed by a homogenizer (IKA ULTRA-TURRAX) at a rotation speed of 5,000 rotations/min for 5 minutes to obtain a monomer emulsion liquid.

Subsequently, 50 parts by mass of the monomer emulsion liquid, 550 parts of ion-exchanged water and 1 part by mass of a surfactant (sodium diphenyl oxide disulfonate) are charged into a vessel with a stirrer, which is warmed in hot bath at 80° C., and after further charging 10 parts by mass of ammonium persulfate (produced by Mitsubishi Gas Chemical Industries Ltd.) as a polymerization initiator, stirring at 200 rpm and warming in hot bath are kept for 1 hour and 10 minutes.

In addition, the remaining monomer emulsion liquid is charged into the vessel at a rate of 3 parts by mass per minute, and after the charging is completed, stirring and warming in hot bath are kept for another 5 hours, whereby Incompatible Resin Particle Dispersion Liquid 1 can be obtained.

The solid content concentration of Incompatible Resin Particle Dispersion Liquid 1 obtained is 40 mass %, and the volume average particle diameter of particles is 200 nm.

### (Preparation of Coloring Agent Dispersion Liquid)

50 Parts by mass of carbon black (Regal 330, produced by CABOT Corporation), 2.5 parts by mass of ionic surfactant Neogen R (produced by Dai-Ichi Kogyo Seiyaku Co., Ltd.), and 150 parts by mass of ion-exchanged water are mixed, dispersed for 10 minutes by a homogenizer (IKA ULTRA-TURRAX), and then subjected to a dispersion treatment using ULTIMIZER. Thereafter, the solid content is adjusted to 30 mass % with ion-exchanged water, whereby a coloring agent dispersion liquid having a central particle diameter of 245 nm is obtained.

### (Preparation of Release Agent Dispersion Liquid)

50 Parts by mass of paraffin wax (HNP0190, produced by Nippon Seiro Co., Ltd.), 2.5 parts by mass of ionic surfactant Neogen R (produced by Dai-Ichi Kogyo Seiyaku Co., Ltd.), and 150 parts by mass of ion-exchanged water are heated at 120° C., and after performing a dispersion treatment using a pressure injection-type Gaulin homogenizer, the solid content is adjusted to 30 mass % with ion-exchanged water, whereby a release agent dispersion liquid having a central particle diameter of 219 nm is obtained.

### Example 1

### Production of Toner 1

638 Parts by mass of the amorphous polyester resin particle dispersion liquid, 128 parts by mass of the crystalline polyester resin particle dispersion liquid, 135 parts by mass of Incompatible Resin Particle Dispersion Liquid 1, 88 parts by mass of the coloring agent dispersion liquid, 175 parts by mass of the release agent dispersion liquid, 2.5 parts by mass of the aluminum, sulfate (produced by Wako Pure Chemical Industries, Ltd.), 50 parts by mass of an aqueous 0.3 M nitric acid solution, and 2,050 parts by mass of ion-exchanged water are put into a 3-liter reaction vessel equipped with a thermometer, a pH meter and a stirrer, and the mixture is kept for 30 minutes at a temperature of 30° C. and a stirring rotation speed of 150 rpm while controlling the temperature by a mantle heater from the outside.

25 Parts by mass of an aqueous 10 mass % aluminum sulfate solution is added while dispersing the contents by a homogenizer (ULTRA-TURRAX T50, manufactured by IKA Japan), and thereafter, an aqueous 0.3 N nitric acid solution is added to adjust the pH in the aggregation step to 3.5. After raising the temperature to 50° C., the particle diameter is measured by a COULTER MULTISIZER II (aperture diameter: 100 μm, manufactured by Coulter), and an aggregate having a volume average particle diameter of 5.5 μm is obtained.

Then, 255 parts by mass of the amorphous polyester resin particle dispersion liquid is additionally added.

Subsequently, 40 parts by mass of an aqueous 10 mass % NTA (nitrilotriacetie acid) metal salt solution (CHELEST 70, manufactured by Chelest) is added, and the pH is adjusted to 9.0 by using an aqueous 1 N sodium hydroxide solution. After raising the temperature to 80° C. at a temperature rise rate of 0.05° C./minute, the system is kept at 80° C. for 3 hours.

Thereafter, nitrogen bubbling is performed for 1 hour while keeping the inside of the system at 80° C., whereby an inert atmosphere is created in the system. To the obtained fused particle dispersion liquid, a polymerization initiator VA-057 (trade name, produced by Wako Pure Chemical Industries, Ltd.) is added in an amount of 2 parts by mass per 100 parts by mass of the fused particle, and after polymerization at 80° C. for 5 hours, the polymerization product is cooled and filtered to obtain a coarse toner particle. Washing is performed by repeating re-dispersion of the coarse toner particle in ion-exchanged water and filtration until the electrical conductivity of the filtrate becomes 20 μS/cm or less, and the dispersion is vacuum-dried in an oven at 40° C. for 5 hours to obtain a toner particle.

1.5 Parts by mass of hydrophobic silica (RY50, produced by Nippon Aerosil Co., Ltd.) and 1.0 parts by mass of hydrophobic titanium oxide (T805, produced by Nippon Aerosil Co., Ltd.) per 100 parts by mass of the obtained toner particle are mixed for 30 seconds at 10,000 rpm by using a sample mill, and the mixture is sieved using a vibration sieve having a mesh size of 45 μm to prepare Toner 1.

The volume average particle diameter of Toner 1 is 5.7 μm, and SF1 is 130. Also, in the surface layer part of the toner particle of Toner 1, a crosslinking product of amorphous polyester resin is contained.

### (Production of Developer)

100 Parts by mass of ferrite particle (produced by Powdertech Co., Ltd., volume average particle diameter: 50 μm) and 1.5 parts by mass of methyl methacrylate resin (produced by Mitsubishi Rayon Co., Ltd., molecular weight: 95,000) are put into a pressurizing kneader together with 500 parts by mass of toluene and mixed with stirring at ordinary temperature (30° C.) for 15 minutes. Thereafter, toluene is distilled off by raising the temperature to 70° C. while mixing the contents under reduced pressure, and the residue is cooled and classified using a sieve of 105 μM to obtain a resin-coated ferrite carrier.

This resin-coated ferrite carrier and Toner 1 are mixed to produce Two-Component Developer 1 having a toner concentration of 7 mass %.

### (Evaluation)

Using a modified machine (modified to enable fixing by an external fixing device in which the fixing temperature is variable) of DocuCentre-IV C4300 (manufactured by Fuji Xerox Co., Ltd.), a solid toner image is formed by adjusting the amount of toner loaded on paper (JD paper) produced by Fuji Xerox Co., Ltd. to 9.8 g/m². After the toner image production, the toner image is fixed using a free belt nip fuser-type external fixing device under Nip of 6.5 mm at a fixing rate of 150 min/sec. At the time of fixing the toner image, the fixing temperature is changed in steps of 5° C., and from the temperature at which low temperature-side offset is generated, the low-temperature fixing property is evaluated based on the following criteria. In Example 1, the evaluation result of low-temperature fixing property

### is AA

### (Evaluation Criteria)

AA: 150° C. or less
B: From more than 150° C. to 170° C. or less
C: More than 170° C.

Incidentally, the occurrence or no occurrence of low temperature-side offset is judged by whether or not the offset becomes a problem in practice.

Furthermore, the degree of variation in the image gloss is evaluated by the gradient of image gloss (60° gloss, three-point average, measured using Micro-TRI-Gloss (device name) manufactured by BYK-Gardner) relative to the temperature in the range of minimum fixing temperature to minimum fixing temperature+20° C. Specifically, image gloss values at respective fixing temperatures of minimum fixing temperature, minimum fixing temperature +5° C., minimum fixing temperature+10° C., minimum fixing temperature+15° C., and minimum fixing temperature+20° C. are plotted by taking the image gloss value as Y axis and the fixing temperature as X axis, and the gradient of the plots is determined.

A smaller gradient indicates a smaller variation in image gloss relative to the fixing temperature and is a preferred embodiment. The evaluation result of the degree of variation in image gloss is AA in Example 1.

### (Evaluation Criteria)

C: The gradient is 0.5 or more.
B: The gradient is from 0.3 to less than 0.5.
A: The gradient is from 0.2 to less than 0.3.
AA: The gradient is less than 0.2.

### Example 2

### Preparation of Incompatible Resin Particle Dispersion Liquid 2

100 Parts by mass of polyester (HIMER ES-508, produced by Sanyo Chemical Industries, Ltd.) is dissolved in 100 parts by mass of ethyl acetate and after further adding 20 parts by mass of TAKENATE D110N (produced by Mitsui Chemicals, Inc.), the contents are stirred and dissolved to obtain a polyester dissolution product.

Subsequently, the polyester dissolution product is added and dispersed while stirring 100 parts by mass of ion-exchanged water having added thereto 10 parts by mass of polyvinyl alcohol (Kuraray Poval PVA217) at a rotation speed of 7,000 rotations/min by a homogenizer (IKA ULTRA-TURRAX), and after the completion of addition, stirring is continued for 10 minutes, Thereafter, the dispersion liquid is heated at 40° C. and charged into 1,000 parts by mass of ion-exchanged water under stirring at a rotation speed of 3,000 rotations/min by a homogenizer (IKA ULTRA-TURRAX), and a solvent removing treatment is performed by continuing stirring and heating for 5 hours, whereby Incompatible Resin Particle Dispersion Liquid 2 having a crosslinked surface layer can be obtained.

Toner 2 is produced in the same manner as in Example 1 except for using Incompatible Resin Particle Dispersion Liquid 2 in place of Incompatible Resin Particle Dispersion liquid 1.

The volume average particle diameter of Toner 2 is 7.0 μm, and SF1 is 120. Also, in the surface layer part of the toner particle of Toner 2, a crosslinking product of amorphous polyester resin is contained.

In Example 2, the evaluation result of low-temperature fixing property is AA, and the evaluation result of the degree of variation in image gloss is AA.

### Example 3

Toner 3 is produced in the same manner as in Example 1 except for changing the fumaric acid in the composition of amorphous polyester resin to maleic acid.

The volume average particle diameter of Toner 3 is 4.7 μm, and SF1 is 135. Also, in the surface layer part of the toner particle of Toner 3, a crosslinking product of amorphous polyester resin is contained.

In Example 3, the evaluation result of low-temperature fixing property is AA, and the evaluation result of the degree of variation in image gloss is A.

### Example 4

Toner 4 is produced in the same manner as in Example 1 except for changing the 1,9-nonanediol in the composition of amorphous polyester resin to 1,6-hexanediol.

The volume average particle diameter of Toner 4 is 6.2 μM, and SF1 is 137. Also, in the surface layer part of the toner particle of Toner 4, a crosslinking product of amorphous polyester resin is contained.

In Example 4, the evaluation result of low-temperature fixing property is AA, and the evaluation result of the degree of variation in image gloss is A.

### Example 5

A composition prepared by mixing 70 parts by mass of the amorphous polyester resin used in Example 1, 10 parts by mass of crystalline polyester resin, 10 parts by mass of incompatible resin particle, 6 parts by mass of a coloring agent dispersion liquid, and 3 parts by mass of WEP-5 (produced by NOF Corporation) as a release agent is kneaded in a Banbury mixer and then pulverized by a jet mill to obtain a toner having an average particle diameter of 7.6 μm, in which the number average fraction of particles of 5 μm or less is 10.0%.

200 Parts by mass of this toner is dispersed in 1,500 parts by mass of water having dissolved therein 0.05 mass % of polyoxyethylene nonylphenyl ether as a nonionic surfactant, and the dispersion is stirred for 30 minutes by a stirrer (Three-One Motor, manufactured by Shinto Scientific Co., Ltd.) until the toner is uniformly wetted, whereby a toner dispersion liquid is prepared.

This toner dispersion liquid is heated to 80° C. with stirring, and a crosslinking reaction in the toner surface is allowed to proceed by charging 10 parts by mass of sodium persulfate (produced by Mitsubishi Gas Chemical Industries Ltd.) as a polymerization initiator. After keeping the system at 80° C. for 1 hour, the reaction product is rapidly cooled with cold water to obtain a toner particle dispersion liquid.

The toner dispersion liquid is filtered and after performing washing by repeating re-dispersion in ion-exchanged water and filtration until the electrical conductivity of the filtrate becomes 20 μS/cm or less, the dispersion is vacuum-dried in an oven at 40° C. for 5 hours to obtain a toner particle.

The volume average particle diameter of Toner 5 is 7.5 μm, and SF1 is 139. Also, in the surface layer part of the toner particle of Toner 5, a crosslinking product of amorphous polyester resin is contained.

In Example 5, the evaluation result of low-temperature fixing property is AA, and the evaluation result of the degree of variation in image gloss is A.

### Comparative Example 1

Toner 6 is produced in the same manner as in Example 1 except for not adding the polymerization initiator VA-057 (trade name, produced by Wako Pure Chemical Industries, Ltd.).

The volume average particle diameter of Toner 6 is 5.7 μm, and SF1 is 128. Also, in the surface layer part of the toner particle of Toner 6, a crosslinking product of amorphous polyester resin is not contained.

In Comparative Example 1, the evaluation result of low-temperature fixing property is AA, and the evaluation result of the degree of variation in image gloss is C.

### Comparative Example 2

Toner 7 is produced by the same operation as in Example 1 except that in Example 1, Incompatible Resin Particle Dispersion Liquid 1 is not added and the amount of the amorphous polyester resin particle dispersion liquid added is changed to 773 parts by mass.

The volume average particle diameter of Toner 7 is 6 μm, and SF1 is 120. Also, in the surface layer part of the toner particle of Toner 7, a crosslinking product of amorphous polyester resin is contained.

In Comparative Example 2, the evaluation result of low-temperature fixing property is AA, and the evaluation result of the degree of variation in image gloss is C.

### Comparative Example 3

Toner 8 is produced by the same operation as in Example 1 except that in Example 1, the crystalline polyester resin particle dispersion liquid is not used and the amount of the amorphous polyester resin particle dispersion liquid added is changed to 766 parts by mass.

The volume average particle diameter of Toner 8 is 5.6 μm, and SF1 is 136. Also, in the surface layer part of the toner particle of Toner 8, a crosslinking product of amorphous polyester resin is contained.

In Comparative Example 3, the evaluation result of low-temperature fixing property is C, and the evaluation result of the degree of variation in image gloss is B,

### (Each Measuring Method)

### <Measuring Method of Particle Diameter>

The measuring method of the particle diameter is described.

In the case where the particle diameter measured is 2 μm or more, Coulter Multisizer-II (manufactured by Coulter) is used as the measuring apparatus, and ISOTON-II (produced by Coulter) is used as the electrolytic solution.

In the case where the particle diameter measured is less than 2 μm, the measurement is performed using a laser diffraction particle size distribution meter (LA-700, manufactured by Horiba, Ltd.).

### <Measuring Method of Molecular Weight>

The molecular weight is measured under the following conditions. GPC is performed using an “HLC-8120GPC, SC-8020 (manufactured by Tosoh Corporation) apparatus”, two “TSKgeI, SuperHM-H (6.0 mm IDx 15 cm, manufactured by Tosoh Corporation)” as the column, and THF (tetrahydrofuran) as an eluent. The experiment is performed using an RI detector under the experimental conditions of a sample concentration of 0.5 mass %, a flow velocity of 0.6 mL/min, a sample injection amount of 10 μL, and a measurement temperature of 40° C. Also, the calibration curve is prepared from 10 samples, “polystyrene standard sample TSK standard”: “A-500”, “F-1”, “F-10”, “F-80”, “F-380”, “A-2500”, “F-4”, “F-40”, “F-128” and “F-700”, produced by Tosoh Corporation.

### <Measuring Method of Glass Transition Temperature>

The glass transition temperature is measured by the DSC (differential scanning calorimeter) measuring method, and a primary maximum peak measured in accordance with ASTMD 3418-8 is determined and taken as the glass transition temperature.

In the measurement of the primary maximum peak, DSC-7 manufactured by Perkin-Elmer is used. For the temperature correction of the detective part of this apparatus, the melting temperatures of indium and zinc are used, and for the calorie correction, the melting heat of indium is used. The sample is measured at a temperature rise rate of 10° C./min by using an aluminum-made pan and setting an empty pan for comparison.

### <Check Whether or not the Surface Layer Part Contains a Crosslinking Product>

Whether or not the surface layer part of the toner (toner particle) contains a crosslinking product is checked by the above-described method.

### <Measurement of tan δ>

The tan δ of the toner is measured by the above-described method. Based on the obtained measurement results, the peak temperature of tan δ, the maximum value of tan δ, and the average gradient of tan δ value relative to temperature are determined.

### (Synthesis of Amorphous Polyester Resin 1)

### —Polyester Resin Having Ethylenically Unsaturated Double Bond—

80 Parts by mol of bisphenol A propylene oxide 2-mol adduct, 20 parts by mol of bisphenol A ethylene oxide 2-mol adduct, 10 parts by mol of terephthalic acid, 30 parts by mol of dodecenylsuccinic acid, 40 parts by mol of fumaric acid, and 0.1 parts by mol of dibutyltin oxide are put into a heated and dried three-neck flask, and after decreasing the pressure in the vessel by a pressure reducing operation and furthermore creating an inert atmosphere with nitrogen gas, the mixture is reacted for 10 hours at 230° C. under normal pressure (101.3 kPa) with mechanical stirring and further reacted for 1 hour at 8 kPa. The reaction product is cooled to 210° C., and 10 parts by mol of trimellitic anhydride is added. This mixture is reacted for 1 hour and thereafter, reacted at 8 kPa until the softening temperature becomes 115° C., whereby an amorphous polyester resin 1 is obtained.

The glass transition temperature of the amorphous polyester resin 1 is 60° C.

### (Preparation of Amorphous Polyester Resin Particle Dispersion Liquid 1)

500 Parts by mass of the amorphous polyester resin 1, 320 parts by mass of methyl ethyl ketone, 125 parts by mass of isopropyl alcohol, and 5.0 parts by mass of an aqueous 10 mass % ammonia solution are put into a separable flask, mixed and dissolved, and ion-exchanged water is then added dropwise by a liquid feeding pump with stirring under heating at 50° C. Subsequently, the solvent is removed under reduced pressure, and after adding 50 parts by mass of an aqueous 20 mass % sodium dodecylbenzenesulfonate solution to the amorphous polyester resin particle dispersion liquid from which the solvent is removed, ion-exchanged water is added to adjust the solid content concentration to 40 mass %, whereby an amorphous polyester resin particle dispersion liquid 1 is obtained. The volume average particle diameter of the obtained polyester resin particle is 190 nm.

### (Synthesis of Crystalline Polyester Resin 1)

45 Parts by mol of 1,9-nonanediol, 55 parts by mol of fumaric acid, and 0.05 parts by mol of dibutyltin oxide are put into a heated and dried three-neck flask, and after raising the temperature while keeping an inert atmosphere by introducing nitrogen gas into the vessel, a condensation polymerization reaction is performed for 2 hours at 150° C. to 230° C. Thereafter, the temperature is gradually raised to 230° C., and the system is stirred for 5 hours and on reaching a viscous state, air-cooled to stop the reaction, whereby a crystalline polyester resin 1 is synthesized.

### (Preparation of Crystalline Polyester Resin Particle Dispersion Liquid 1)

3,000 Parts by mass of the obtained crystalline polyester resin 1, 10,000 parts by mass of ion-exchanged water, and 60 parts by mass of sodium dodecylbenzenesulfonate are put into an emulsifying tank of a high-temperature and high-pressure emulsifying apparatus (CAVITRON CD1010), and the mixture is heated and melted at 130° C., then dispersed at 110° C., a flow rate of 3 L/m and 10,000 rpm for 30 minutes and furthermore, passed through a cooling tank to produce a crystalline polyester resin particle dispersion liquid 1 having a solid content of 40 mass % and a volume average particle diameter D50v of 125 nm.

### (Preparation of Coloring Agent Dispersion Liquid 1)

50 Parts by mass of carbon black (Regal 330, produced by CABOT Corporation), 2.5 parts by mass of ionic surfactant Neogen R (produced by Dai-Ichi Kogyo Seiyaku Co., Ltd.), and 150 parts by mass of ion-exchanged water are mixed, dispersed for 10 minutes by a homogenizer (IKA ULTRA-TURRAX), and then subjected to a dispersion treatment using ULTIMIZER. Thereafter, the solid content is adjusted to 30 mass % with ion-exchanged water, whereby a coloring agent dispersion liquid 1 having a central particle diameter of 245 nm is obtained.

### (Preparation of Release Agent Dispersion Liquid 1)

50 Parts by mass of paraffin wax (HNP9, produced by Nippon Seiro Co., Ltd.), 2.5 parts by mass of ionic surfactant Neogen R (produced by Dai-Ichi Kogyo Seiyaku Co., Ltd.), and 150 parts by mass of ion-exchanged water are heated at 120° C., and after performing a dispersion treatment using a pressure injection-type Gaulin homogenizer, the solid content is adjusted to 30 mass % with ion-exchanged water, whereby a release agent dispersion liquid 1 having a central particle diameter of 219 nm is obtained.

### Example 2-1

### Production of Toner 1A

638 Parts by mass of the amorphous polyester resin particle dispersion liquid 1, 128 parts by mass of the crystalline polyester resin particle dispersion liquid 1, 88 parts by mass of the coloring agent dispersion liquid 1, 175 parts by mass of the release agent dispersion liquid 1, 50 parts by mass of an aqueous 0.3 M nitric acid solution, and 2,050 parts by mass of ion-exchanged water are put into a 3-liter reaction vessel equipped with a thermometer, a pH meter and a stirrer, and the mixture is kept for 30 minutes at a temperature of 30° C. and a stirring rotation speed of 150 rpm while controlling the temperature by a mantle heater from the outside.

25 Parts by mass of an aqueous 10 mass % aluminum sulfate (produced by Wako Pure Chemical Industries, Ltd.) solution is added while dispersing the contents by a homogenizer (ULTRA-TURRAX T50, manufactured by IKA Japan), and thereafter, an aqueous 0.3 N nitric acid solution is added to adjust the pH in the aggregation step to 3.5. After raising the temperature to 50° C., the particle diameter is measured by a COULTER MULTISIZER II (aperture diameter: 100 μm, manufactured by Coulter), and an aggregate having a volume average particle diameter of 5.5 μm is obtained.

Then, 255 parts by mass of the amorphous polyester resin particle dispersion liquid 1 is additionally added.

Subsequently, 40 parts by mass of an aqueous 10 mass % NTA (nitrilotriacetic acid) metal salt solution (CHELEST 70, manufactured by Chelest) is added, and the pH is adjusted to 9.0 by using an aqueous 1 N sodium hydroxide solution. After raising the temperature to 80° C. at a temperature rise rate of 0.05° C./minute, the system is kept at 80° C. for 3 hours.

Thereafter, nitrogen bubbling is performed for 1 hour while keeping the inside of the system at 80° C., whereby an inert atmosphere is created in the system. To the obtained fused particle dispersion liquid, a polymerization initiator VA-057 (trade name, produced by Wako Pure Chemical Industries, Ltd.) is added in an amount of 2 parts by mass per 100 parts by mass of the fused particle, and after polymerization at 80° C. for 5 hours, the polymerization product is cooled and filtered to obtain a coarse toner particle (crosslinking step). Washing is performed by repeating re-dispersion of the coarse toner particle in ion-exchanged water and filtration until the electrical conductivity of the filtrate becomes 20 μS/cm or less, and the dispersion is vacuum-dried in an oven at 40° C. for 5 hours to obtain a toner particle.

1.5 Parts by mass of hydrophobic silica (RY50, produced by Nippon Aerosil Co., Ltd.) and 1.0 parts by mass of hydrophobic titanium oxide (T805, produced by Nippon Aerosil Co., Ltd.) per 100 parts by mass of the obtained toner particle are mixed for 30 seconds at 10,000 rpm by using a sample mill (external addition step), and the mixture is sieved using a vibration sieve having a mesh size of 45 μm to prepare Toner 1A.

The volume average particle diameter of Toner 1A is 5.6 μm, and SF1 is 123. Also, in the surface layer part of the toner particle of Toner 1, a crosslinking product of amorphous polyester resin is contained.

The measurement result of tan 8 of the toner is shown in Table 1.

### (Production of Developer)

100 Parts by mass of ferrite particle (produced by Powdertech Co., Ltd., volume average particle diameter: 50 μm) and 1.5 parts by mass of methyl methacrylate resin (produced by Mitsubishi Rayon Co., Ltd., molecular weight: 95,000) are put into a pressurizing kneader together with 500 parts by mass of toluene and mixed with stirring at ordinary temperature (30° C.) for 15 minutes. Thereafter, toluene is distilled off by raising the temperature to 70° C. while mixing the contents under reduced pressure, and the residue is cooled and classified using a sieve of 105 μm to obtain a resin-coated ferrite carrier.

This resin-coated ferrite carrier and Toner 1A are mixed to produce Two-Component Developer 1A having a toner concentration of 7 mass %.

### (Evaluation)

Using a modified machine of Satera LBP5050 (manufactured by Canon Inc.) where the toner in the toner cartridge and the developer in the developing vessel are replaced respectively by Toner 1A and Two-Component Developer 1A, Solid Image 1 of 5 cm×4 cm is formed, and the amount of toner loaded per area is adjusted to 10 [g/m²] by changing the internal parameters.

Subsequently, 100 sheets each having an image for evaluation are ejected by continuous printing using C2 Paper (produced by Fuji Xerox Co., Ltd.) as the sheet, and within 10 seconds after ejecting the 100th sheet, 2,900 sheets of unprinted C2 paper are further placed on the ejected 100 sheets and left standing still for 17 hours or more.

Printed 100 sheets are taken out from the stationary sheets and peeled apart from each other, and the degree of back transfer is evaluated by observing to what extent a sheet and a sheet are adhered by the toner.

The evaluation results obtained are shown in Table 1.

### (Evaluation Criteria)

AA: Sheets are not adhered, allowing for resistance-less peeling apart of sheets and no occurrence of a damage to image.
A: No resistance or slight resistance is experienced when peeling apart the sheets, and the damage to image is null or at a level of causing no problem in practical use.
C: Apparent resistance is experienced when peeling apart the sheets, or the damage to image due to offset or the like becomes a problem in practical use.

### Example 2-2

50 Parts by mass of the crystalline polyester resin 1 used in Example 2-1, 255 parts by mass of amorphous polyester resin 1, 34 parts by mass of a coloring agent dispersion liquid 1 and 56 parts by mass of ethyl acetate are stirred, and 75 parts by mass of a wax dispersion liquid is added to the mixture. The obtained mixture is thoroughly stirred until the system becomes uniform (this liquid is designated as Liquid A), On the other hand, 100 parts by mass of a calcium carbonate dispersion liquid obtained by dispersing 40 parts by mass of calcium carbonate in 60 parts by mass of water, 99 parts by mass of an aqueous 2 mass % CELLOGEN BS-H (produced by Dai-ichi Kogyo Seiyaku Co., Ltd.), and 157 parts by mass of water are stirred for 5 minutes by using a homogenizer (ULTRA-TURRAX, manufactured by IKA) (this liquid is designated as Liquid B),

Furthermore, 345 parts by mass of Liquid B and 250 parts by mass of Liquid A are stirred using a homogenizer (ULTRA-TURRAX, manufactured by IKA) to suspend the mixed liquid. This mixed liquid is stirred by a propeller-type stirrer for 48 hours at room temperature (for example, 25° C.) under atmospheric pressure to remove the solvent, Thereafter, hydrochloric acid is added to the mixed liquid and after removing calcium carbonate, the reaction mixture is washed with water.

Subsequently, the temperature is raised to 80° C. while again stirring the mixed liquid, and 15 parts by mass of a polymerization initiator (sodium persulfate, produced by Mitsubishi Gas Chemical Industries Ltd.). The system is kept at 80° C. for 30 minutes with stirring, and through water washing, drying and classification, a toner particle is obtained. The average particle diameter of the toner particle is 6 μm.

A toner is obtained by performing the same treatments as in Example 2-1 after the external addition step and subjected to the same evaluations.

The evaluation results obtained are shown in Table 1.

### Example 2-3

A composition prepared by mixing 70 parts by mass of the amorphous polyester resin 1 used in Example 2-1, 10 parts by mass of crystalline polyester resin 1, 6 parts by mass of a coloring agent dispersion liquid 1, and 3 parts by mass of WEP-5 (produced by NOF Corporation) as a release agent is kneaded in a Banbury mixer and then pulverized by a jet mill to obtain a toner having an average particle diameter of 7.6 μm, in which the number average fraction of particles of 5 μm or less is 10.0%.

200 Parts by mass of this toner particle is dispersed in 1,500 parts by mass of water having dissolved therein 0.05 mass % of polyoxyethylene nonylphenyl ether as a nonionic surfactant, and the dispersion is stirred for 30 minutes by a stirrer (Three-One Motor, manufactured by Shinto Scientific Co., Ltd.) until the toner particle is uniformly wetted, whereby a toner particle dispersion liquid is prepared.

This toner particle dispersion liquid is heated to 80° C. with stirring, and a crosslinking reaction in the toner particle surface is allowed to proceed by charging 10 parts by mass of sodium persulfate (produced by Mitsubishi Gas Chemical Industries Ltd.) as a polymerization initiator. After keeping the system at 80° C. for 1 hour, the reaction product is rapidly cooled with cold water to obtain a toner particle dispersion liquid after crosslinking treatment.

The toner particle dispersion liquid after crosslinking treatment is filtered and after performing washing by repeating re-dispersion in ion-exchanged water and filtration until the electrical conductivity of the filtrate becomes 20 μS/cm or less, the dispersion is vacuum-dried in an oven at 40° C. for 5 hours to obtain a toner particle. The average particle diameter of this toner particle is 7.2 μm.

A toner is obtained by performing the same treatments as in Example 1 after the external addition step and subjected to the same evaluations.

The evaluation results obtained are shown in Table 1.

### Example 2-4

An amorphous polyester resin is synthesized by changing the constituent ratio of alcohol monomers in the amorphous polyester resin 1 of Example 2-1 to 10 parts by mol of bisphenol A propylene oxide 2-mol adduct and 90 parts by mol of bisphenol A ethylene oxide 2-mol adduct. Furthermore, in the toner production process of Example 2-1, after cooling subsequent to the crosslinking step, the temperature is again raised to 50° C. with stirring, and the system is kept for 2 hours and then rapidly cooled. A toner is obtained by performing the same treatments as in Example 1 in the process after the rapid cooling step and subjected to the same evaluations.

The evaluation results obtained are shown in Table 1.

### Example 2-5

A toner is obtained by performing the same operations as in Example 2-1 except for changing the fumaric acid used in the synthesis of the amorphous polyester resin 1 of Example 2-1 to maleic acid and subjected to the same evaluations.

The evaluation results obtained are shown in Table 1.

### Example 2-6

A toner is obtained by performing the same operations as in Example 2-1 but using a crystalline polyester resin synthesized in the same manner except for changing the 1,9-nonanediol out of monomers constituting the crystalline polyester resin 1 of Example 2-1 to 1,6-hexanediol and subjected to the same evaluations.

The evaluation results obtained are shown in Table 1.

### Comparative Example 2-1

A toner is obtained by performing the same operations as in Example 2-1 except that out of operations in Example 2-1, nitrogen bubbling, addition of an initiator and polymerization are not performed, and subjected to the same evaluations.

The evaluation results obtained are shown in Table 1.

### Comparative Example 2-2

A toner is obtained by performing the same operations as in Example 2-1 except that the amount of the amorphous polyester resin particle dispersion liquid 1 in Example 2-1 is changed to 766 parts by mass and the crystalline polyester resin particle dispersion liquid 1 is not used, and subjected to the same evaluations.

The evaluation results obtained are shown in Table 1.

### Comparative Example 2-3

A toner is obtained by performing the same operations as in Example 2-1 except that the ratio of acid monomers constituting the amorphous polyester resin 1 of Example 2-1 is changed to 10 parts by mol of terephthalic acid, 40 parts by mol of dodecenylsuccinic acid and 40 parts by mol of fumaric acid, and subjected to the same evaluations, but serious back transfer and coagulation of the developer during the evaluation are caused, and the toner is judged as being incapable of withstanding the practical use.

The evaluation results obtained are shown in Table 1.

### Comparative Example 2-4

A toner is obtained by performing the same operations as in Example 2-1 except that out of acid monomers constituting the amorphous polyester resin 1 of Example 2-1, the terephthalic acid is changed to 60 parts by mol, the dodecenyisuccinic acid is changed to 5 parts by mol and the fumaric acid is changed to 30 parts by mol, and subjected to the same evaluations.

The evaluation results obtained are shown in Table 1.

### Comparative Example 2-5

### Production of Amorphous Resin Dispersion Liquid

480 Parts by mass of styrene, 120 parts by mass of butyl acrylate, and 6 parts by mass of carboxyethyl acrylate are added to a dispersion medium obtained by dissolving 6 parts by mass of a surfactant (sodium diphenyl oxide disulfonate) in 250 parts by mass of ion-exchanged water, and dispersed by a homogenizer (JKA ULTRA-TURRAX) at a rotation speed of 5,000 rotations/min for 5 minutes to obtain a monomer emulsion liquid.

Subsequently, 50 parts by mass of the monomer emulsion liquid, 550 parts by mass of ion-exchanged water and 1 part by mass of a surfactant (sodium diphenyl oxide disulfonate) are charged into a vessel with a stirrer, which is warmed in hot bath at 80° C., and after further charging 10 parts by mass of ammonium persulfate (produced by Mitsubishi Gas Chemical Industries Ltd.) as a polymerization initiator, stirring at 200 rpm and warming in hot bath are kept for 1 hour and 10 minutes.

In addition, the remaining monomer emulsion liquid is charged into the vessel at a rate of 3 parts by mass per minute, and after the charging is completed, stirring and warming in hot bath are kept for another 5 hours. Thereto, an aqueous 1 M sodium hydroxide is added to adjust the pH to 4, whereby an amorphous resin dispersion liquid is obtained.

The solid content concentration of the amorphous resin dispersion liquid obtained is 40 mass %, and the volume average particle diameter of the resin particle is 200 nm.

A toner is obtained by using the amorphous resin dispersion liquid in place of the amorphous polyester resin particle dispersion liquid 1 in the operations of Example 2-1 and subjected to the same evaluations.

The evaluation results obtained are shown in Table 1.

TABLE 1

| | Peak | | | |
|---|---|---|---|---|
| | Temperature | Maximum | Average | |
| | of tan δ | Value | Gradient | Back |
| | (° C.) | tan δ | (° C.⁻¹) | Transfer |
| Example 2-1 | 57 | 1.7 | 0.13 | AA |
| Example 2-2 | 56 | 1.8 | 0.12 | AA |
| Example 2-3 | 60 | 1.9 | 0.13 | AA |
| Example 2-4 | 57 | 2.0 | 0.12 | AA |
| Example 2-5 | 55 | 1.6 | 0.11 | A |
| Example 2-6 | 60 | 2.0 | 0.13 | AA |
| Comparative | 55 | 1.5 | 0.09 | C |
| Example 2-1 | | | | |
| Comparative | 63 | 1.4 | 0.09 | C |
| Example 2-2 | | | | |
| Comparative | 48 | 1.6 | 0.10 | C |
| Example 2-3 | | | | |
| Comparative | 72 | 1.8 | 0.12 | C |
| Example 2-4 | | | | |
| Comparative | 68 | 2.3 | 0.09 | C |
| Example 2-5 | | | | |

### DESCRIPTION OF REFERENCE NUMERALS AND SIGNS

1Y, 1M, 1C, 1K: Photoreceptor (one example of the image holding member)
2Y, 2M, 2C, 2K: Charging roller (one example of the charging unit)
3: Exposure device (one example of the electrostatic image forming unit)
3Y, 3M, 3C, 3K: Laser beam
4Y, 4M, 4C, 4K: Developing device (one example of the developing unit)
5Y, 5M, 5C, 5K: Primary transfer roller (one example of the primary transfer unit)
6Y, 6M, 6C, 6K: Photoreceptor cleaning device (one example of the cleaning unit)
8Y, 8M, 8C, 8K: Toner cartridge
10Y, 10M, 10C, 10K: Image forming unit
20: Intermediate transfer belt (one example of the intermediate transfer material)
22: Driving roller
24: Supporting roller
26: Secondary transfer roller (one example of the secondary transfer unit)
30: Intermediate transfer material cleaning device
107: Photoreceptor (one example of the image holding member)
108: Charting roller (one example of the charging unit)
109: Exposure device (one example of the electrostatic image forming unit)
111: Developing device (one example of the developing unit)
112: Transfer device (one example of the transfer unit)
113: Photoreceptor cleaning device (one example of the cleaning unit)
115: Fixing device (one example of the fixing unit)
116: Mounting rail
117: Casing
118: Opening for exposure
200: Process cartridge
300: Recording paper (one example of the recording medium)
P: Recording paper sheet (one example of the recording medium)

What is claimed is:

1. An electrostatic image-developing toner comprising:
an amorphous polyester resin,
a crystalline polyester resin, and
a resin particle incompatible with the amorphous polyester resin,
wherein
the amorphous polyester resin contains an amorphous polyester resin having an ethylenically unsaturated bond, and
a surface layer part contains a crosslinking product of the amorphous polyester resin having an ethylenically unsaturated bond.

2. The electrostatic image-developing toner as claimed in claim 1,
wherein the resin particle is a vinyl-based resin particle.

3. An electrostatic image-developing toner comprising:
an amorphous polyester resin, and
a crystalline polyester resin,
wherein
the amorphous polyester resin contains an amorphous polyester resin having an ethylenically unsaturated bond,
a surface layer part contains a erosslinking product of said amorphous polyester resin having an ethylenically unsaturated bond,
a maximum value of tan δ is present in the range of 50° C. to 70° C.,
a maximum value of tan δ is 1 or more, and
an average gradient of the tan δ value relative to the temperature in the range between a temperature lower by 10° C. and a temperature lower by 4° C., than the temperature exhibiting the maximum value of tan δ, is 0.10° C.⁻¹ or more.

4. The electrostatic image-developing toner as claimed in claim 3,
wherein
a melting temperature of the crystalline polyester resin is 70° C. or more, and
a percentage of a structural unit derived from fumaric acid in the total amount of structural units derived from carboxylic acid components constituting the crystalline polyester resin is 30 mol % or more.

5. An electrostatic image developer comprising the electrostatic image-developing toner claimed in claim 1.

6. An electrostatic image developer comprising the electrostatic image-developing toner claimed in claim 3.

7. A toner cartridge housing the electrostatic image-developing toner claimed in claim 1, which is detachably mounted in an image forming apparatus.

8. A toner cartridge housing the electrostatic image-developing toner claimed in claim 3, which is detachably mounted in an image forming apparatus.

9. A process cartridge housing the electrostatic image developer claimed in claim 5 and having a developing unit that develops an electrostatic image formed on the surface of an image holding member with the electrostatic image developer to form a toner image, wherein
the process cartridge is detachably mounted in an image forming apparatus.

10. A process cartridge housing the electrostatic image developer claimed in claim 6 and having a developing unit that develops an electrostatic image formed on the surface of an image holding member with the electrostatic image developer to form a toner image, wherein
the process cartridge is detachably mounted in an image forming apparatus.

11. An image forming apparatus comprising:
an image holding member,
a charging unit that charges the surface of the image holding member,
an electrostatic image forming unit that forms an electrostatic image on the charged surface of the image holding member,
a developing unit that houses the electrostatic image developer claimed in claim 5 and develops the electrostatic image formed on the surface of the image holding member with the electrostatic image developer to form a toner image,
a transfer unit that transfers the toner image formed on the surface of the image holding member onto the surface of a recording medium, and
a fixing unit that fixes the toner image transferred onto the surface of the recording medium.

12. An image forming apparatus comprising:
an image holding member,
a charging unit that charges the surface of the image holding member,
an electrostatic image forming unit that forms an electrostatic image on the charged surface of the image holding member,
a developing unit that houses the electrostatic image developer claimed in claim 6 and develops the electrostatic image formed on the surface of the image holding member with the electrostatic image developer to form a toner image,
a transfer unit that transfers the toner image formed on the surface of the image holding member onto the surface of a recording medium, and
a fixing unit that fixes the toner image transferred onto the surface of the recording medium.
